(19) United States
(12) Patent Application Publication
(10) Pub. No.: US 2018/0089762 A1
(43) Pub. Date: Mar. 29, 2018

(54) HIERARCHICAL CONSTRUCTION OF INVESTMENT PORTFOLIOS USING CLUSTERED MACHINE LEARNING

(71) Applicant: Marcos López de Prado, Harrison, NY (US)

(72) Inventor: Marcos López de Prado, Harrison, NY (US)

(21) Appl. No.: 15/721,279

(22) Filed: Sep. 29, 2017

Related U.S. Application Data
(60) Provisional application No. 62/401,678, filed on Sep. 29, 2016.

(51) Int. Cl. G06Q 40/06; G06N 99/00

(52) U.S. Cl. CPC G06Q 40/06; G06F 17/30312; G06N 99/005

(57) ABSTRACT

Described herein are methods and system for generating a hierarchical data structure. A cluster of server computing devices receives a matrix of observations, derives a robust covariance matrix, and divides the matrix of observations into a plurality of computation tasks. Each processor in the cluster generates a first data structure for a distance matrix based upon a corresponding task, the distance matrix comprising a plurality of items, and clusters the items to generate a clustered distance matrix. Each processor generates a second data structure for a linkage matrix using the clustered matrix. Each processor reorganizes rows and columns of the linkage matrix to generate a quasi-diagonal matrix and recursively bisects the quasi-diagonal matrix. Each processor generates a third data structure containing the clusters and assigned weights. Each third data structure is consolidated into a solution vector, which is transmitted to a remote computing device.

### RELATED APPLICATIONS

This application claims priority to U.S. Provisional Patent Application No. 62/401,678, filed on Sep. 29, 2016, the entirety of which is incorporated herein by reference.

### TECHNICAL FIELD

The subject matter of this application relates generally to methods and apparatuses, including computer program products, for generating optimized construction of investment portfolios using clustered machine learning methods that recognize a hierarchical structure in the data. In particular, the methods and systems described herein provide a solution to the problem of generating outperformance out-of-sample, as opposed to the standard approach of optimizing performance in-sample.

### BACKGROUND

Portfolio construction is perhaps the most recurrent financial problem. On a daily basis, investment managers must build portfolios that incorporate their views and forecasts on risks and returns. This is the primordial question that twenty-four year-old Harry Markowitz attempted to answer more than sixty years ago. His monumental insight was to recognize that various levels of risk are associated with different “optimal” portfolios in terms of risk-adjusted returns, hence the notion of “efficient frontier” as described in Markowitz, H., “Portfolio selection,” Journal of Finance, Vol. 7 (1952), pp. 77-91. An implication was that it is rarely optimal to allocate all the capital to the investments with highest expected returns. Instead, we should take into account the correlations across alternative investments in order to build a diversified portfolio.

Before earning his Ph.D. in 1954, Markowitz left academia to work for the RAND Corporation, where he developed the Critical Line Algorithm (CLA). CLA is a quadratic optimization procedure specifically designed for inequality-constrained portfolio optimization problems, using the then recently discovered Karush-Kuhn-Tucker conditions as described in Kuhn, H. W. and A. W. Tucker, “Nonlinear programming,” Proceeds of 2^{nd} Berkeley Symposium, Berkeley: University of California Press (1952), pp. 481-492. This algorithm is notable in that it guarantees that the exact solution is found after a known number of iterations. A description and open-source implementation of this algorithm can be found in Bailey, D. and M. Lopez de Prado, “An open-source implementation of the critical-line algorithm for portfolio optimization,” Algorithms, Vol. 6, No. 1 (2013), pp. 169-196 (available at http://ssrn.com/abstract=2197616). Surprisingly, most financial practitioners still seem unaware of CLA, as they often rely on generic-purpose quadratic programming methods that do not guarantee the correct solution or a stopping time.

Despite of the brilliance of Markowitz's theory, a number of practical problems make CLA solutions somewhat unreliable. A major caveat is that small deviations in the forecasted returns cause CLA to produce very different portfolios, as described in Michaud, R., Efficient asset allocation: A practical guide to stock portfolio optimization and asset allocation, Boston: Harvard Business School Press (1998). Given that returns can rarely be forecasted with sufficient accuracy, many authors have opted for dropping them altogether and focus on the covariance matrix. This has led to risk-based asset allocation approaches, of which “risk parity” is a prominent example, as described in Jurczenko, E., “Risk-Based and Factor Investing,” Elsevier Science (2015). Dropping the forecasts on returns improves however does not prevent the instability issues. The reason is, quadratic programming methods require the inversion of a positive-definite covariance matrix (all eigenvalues must be positive). This inversion is prone to large errors when the covariance matrix is numerically ill-conditioned, i.e. it has a high condition number—as described in Bailey, D. and M. Lopez de Prado, “Balanced Baskets: A new approach to Trading and Hedging Risks,” Journal of Investment Strategies, Vol. 1, No. 4 (2012), pp. 21-62, (available at http://ssrn.com/abstract=20166170).

The condition number of a covariance, correlation (or normal, thus diagonalizable) matrix is the absolute value of the ratio between its maximal and minimal (by moduli) eigenvalues. FIG. 1A plots the sorted eigenvalues of several correlation matrices, where the condition number is the ratio between the first and last values of each line. This number is lowest for a diagonal correlation matrix, which is its own inverse. As we add correlated (multicollinear) investments, the condition number grows. At some point, the condition number is so high that numerical errors make the inverse matrix too unstable: a small change on any entry will lead to a very different inverse. This is Markowitz's curse: the more correlated the investments, the greater the need for diversification and yet the more likely we will receive unstable solutions. The benefits of diversification often are more than offset by estimation errors.

Increasing the size of the covariance matrix will only make matters worse, as each covariance is estimated with fewer degrees of freedom. In general, we need at least ½ N(N+1) independent and identically distributed (IID) observations in order to estimate a covariance matrix of size N that is not singular. For example, estimating an invertible covariance matrix of size fifty requires at the very least five years' worth of daily IID data. As most investors know, correlation structures do not remain invariant over such long periods by any reasonable confidence level. The severity of these challenges is epitomized by the fact that even naïve (equally-weighted) portfolios have been shown to beat mean-variance and risk-based optimization in practice—for example, as described in De Miguel, V., L. Garlappi and R. Uppal, R., “Optimal versus naïve diversification: How inefficient is the 1/N portfolio strategy?,” Review of Financial Studies, Vol. 22 (2009), pp. 1915-1953.

These instability concerns have received substantial attention in recent years, as some have carefully detailed—such as Kolm, P., R. Tutuncu and F. Fabozzi, “60 years of portfolio optimization,” European Journal of Operational Research, Vol. 234, No. 2 (2010), pp. 356-371. Most alternatives attempt to achieve robustness by incorporating additional constraints (see Clarke, R., H. De Silva, and S. Thorley, “Portfolio constraints and the fundamental law of active management,” Financial Analysts Journal, Vol. 58 (2002), pp. 48-66), introducing Bayesian priors (see Black, F. and R. Litterman, “Global portfolio optimization,” Financial Analysts Journal, Vol. 48 (1992), pp. 28-43) or improving the numerical stability of the covariance matrix's inverse (see Ledoit, O. and M. Wolf, “Improved Estimation of the Covariance Matrix of Stock Returns with an Application to Portfolio Selection,” Journal of Empirical Finance, Vol. 10, No. 5 (2003), pp. 603-621).

All the methods discussed so far, although published in recent years, are derived from (very) classical areas of mathematics: Geometry and linear algebra. A correlation matrix is a linear algebra object that measures the cosines of the angles between any two vectors in the vector space formed by the returns series (see Calkin, N. and M. López de Prado, “Stochastic Flow Diagrams,” Algorithmic Finance, Vol. 3, No. 1 (2014), pp. 21-42 (available at http://ssrn.com/abstract=2379314); also see Calkin, N. and M. López de Prado, “The Topology of Macro Financial Flows: An Application of Stochastic Flow Diagrams,” Algorithmic Finance, Vol. 3, No. 1 (2014), pp. 43-85 (available at http://ssrn.com/abstract=2379319). One reason for the instability of quadratic optimizers is that the vector space is modelled as a complete (fully connected) graph, where every node is a potential candidate to substitute another. In algorithmic terms, inverting the matrix means evaluating the rates of substitution across the complete graph.

FIG. 1B depicts a visual representation of the relationships implied by a covariance matrix of 50×50, that is fifty nodes and 1225 edges. Small estimation errors over several edges compound to lead us to incorrect solutions. Intuitively it would be desirable to drop unnecessary edges.

Let's consider for a moment the practical implications of such topological structure. Suppose that an investor wishes to build a diversified portfolio of securities, including hundreds of stocks, bonds, hedge funds, real estate, private placements, etc. Some investments seem closer substitutes of one another, and other investments seem complementary to one another. For example, stocks could be grouped in terms of liquidity, size, industry, and region, where stocks within a given group compete for allocations. In deciding the allocation to a large publicly-traded U.S. financial stock like J.P. Morgan, we will consider adding or reducing the allocation to another large publicly-traded U.S. bank like Goldman Sachs, rather than a small community bank in Switzerland, or a real estate holding in the Caribbean. And yet, to a correlation matrix, all investments are potential substitutes to each other. In other words, correlation matrices lack the notion of hierarchy. This lack of hierarchical structure allows weights to vary freely in unintended ways, which is a root cause of CLA's instability.

Furthermore, existing computing systems—even systems with advanced processing capabilities—that handle functions such as portfolio performance simulation and optimization do not typically leverage more sophisticated software-based data processing techniques that can only be performed by specialized computers, often operating in high-density computing clusters operating in parallel and executing advanced data processing techniques such as machine learning and artificial intelligence.

### SUMMARY

Therefore, what is needed is a specialized computing system, including a cluster of server computing devices, that is programmed to execute machine learning techniques in parallel using complex software, including algorithms and processes to implement a hierarchical data structure that enables the computing system to traverse a computer-generated model to determine an optimal allocation for a portfolio of assets.

FIG. 1C depicts a visual representation of a hierarchical (tree) structure as generated by the clustered machine learning techniques described herein. It should be appreciated that a tree structure introduces two desirable features: a) It has only N−1 edges to connect N nodes, so the weights only rebalance among peers at various hierarchical levels; and b) the weights are distributed top-down, consistent with how many asset managers build their portfolios, from asset class to sectors to individual securities. For these reasons, hierarchical structures are designed to give not only stable but also intuitive results.

The invention, in one aspect, features a system for generating a hierarchical data structure using clustering machine learning algorithms. The system comprises a cluster of server computing devices communicably coupled to each other and to a database computing device, each server computing device having one or more machine learning processors. The cluster of server computing devices is programmed to receive a) a matrix of observations. The cluster of server computing devices is programmed to b) derive a robust covariance matrix from the matrix of observations. The cluster of server computing devices is programmed to c) divide the matrix of observations into a plurality of computation tasks and transmit each one of the plurality of computation tasks to a corresponding machine learning processor. Each machine learning processor is programmed to d) generate a first data structure for a distance matrix based upon the corresponding computation task. The distance matrix comprises a plurality of items. Each machine learning processor is programmed to e) determine a distance between any two column-vectors of the distance matrix, and f) generate a cluster of items using a pair of columns associated with the two column-vectors. Each machine learning processor is programmed to g) define a distance between the cluster and unclustered items of the distance matrix, and h) update the distance matrix by appending the cluster and defined distance to the distance matrix and dropping clustered columns and rows of the distance matrix. Each machine learning processor is programmed to i) append one or more additional clusters to the distance matrix by repeating steps f)-h) for each additional cluster. Each machine learning processor is programmed to j) generate a second data structure for a linkage matrix using the clustered distance matrix. Each machine learning processor is programmed to k) reorganize rows and columns of the linkage matrix to generate a quasi-diagonal matrix, and l) recursively bisect the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance. Each machine learning processor is programmed to m) generate a third data structure containing the clusters and assigned weights. The cluster of server computing devices is programmed to n) consolidate each third data structure from each machine learning processor into a solution vector and transmit the solution vector to a remote computing device.

The invention, in another aspect, features a computerized method of generating a hierarchical data structure using clustering machine learning algorithms. The method comprises a) receiving, by a cluster of server computing devices communicably coupled to each other and to a database computing device and each server computing device comprising one or more machine learning processors, a matrix of observations. The cluster of server computing devices b) derives a robust covariance matrix from the matrix of observations. The cluster of server computing devices c) divides the matrix of observations into a plurality of computation tasks and transmits each one of the plurality of computation tasks to a corresponding machine learning processor. Each machine learning processor d) generates a first data structure for a distance matrix based upon the corresponding computation task. The distance matrix comprises a plurality of items. Each machine learning processor e) determines a distance between any two column-vectors of the distance matrix, and f) generates a cluster of items using a pair of columns associated with the two column-vectors. Each machine learning processor g) defines a distance between the cluster and unclustered items of the distance matrix, and h) updates the distance matrix by appending the cluster and defined distance to the distance matrix and dropping clustered columns and rows of the distance matrix. Each machine learning processor i) appends one or more additional clusters to the distance matrix by repeating steps f)-h) for each additional cluster. Each machine learning processor j) generates a second data structure for a linkage matrix using the clustered distance matrix. Each machine learning processor k) reorganizes rows and columns of the linkage matrix to generate a quasi-diagonal matrix, and l) recursively bisects the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance. Each machine learning processor m) generates a third data structure containing the clusters and assigned weights. The cluster of server computing devices n) consolidates each third data structure from each machine learning processor into a solution vector and transmits the solution vector to a remote computing device.

The invention, in another aspect, features a computer program product, tangibly embodied in a non-transitory computer readable storage device, for generating a hierarchical data structure using clustering machine learning algorithms. The computer program product includes instructions that when executed, cause a cluster of server computing devices communicably coupled to each other and to a database computing device, each server computing device comprising one or more machine learning processors, to a) receive a matrix of observations. The cluster of server computing devices b) derives a robust covariance matrix from the matrix of observations. The cluster of server computing devices c) divides the matrix of observations into a plurality of computation tasks and transmits each one of the plurality of computation tasks to a corresponding machine learning processor. Each machine learning processor d) generates a first data structure for a distance matrix based upon the corresponding computation task. The distance matrix comprises a plurality of items. Each machine learning processor e) determines a distance between any two column-vectors of the distance matrix, and f) generates a cluster of items using a pair of columns associated with the two column-vectors. Each machine learning processor g) defines a distance between the cluster and unclustered items of the distance matrix, and h) updates the distance matrix by appending the cluster and defined distance to the distance matrix and dropping clustered columns and rows of the distance matrix. Each machine learning processor i) appends one or more additional clusters to the distance matrix by repeating steps f)-h) for each additional cluster. Each machine learning processor j) generates a second data structure for a linkage matrix using the clustered distance matrix. Each machine learning processor k) reorganizes rows and columns of the linkage matrix to generate a quasi-diagonal matrix, and l) recursively bisects the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance. Each machine learning processor m) generates a third data structure containing the clusters and assigned weights. The cluster of server computing devices n) consolidates each third data structure from each machine learning processor into a solution vector and transmitting the solution vector to a remote computing device.

Any of the above aspects can include one or more of the following features. In some embodiments, generating a first data structure for a distance matrix further comprises generating robust covariance and correlation matrices based upon the computation task; defining a distance measure using the correlation matrix; and generating the first data structure based upon the correlation matrix and the distance. In some embodiments, the distance between any two column-vectors of the distance matrix comprises a proper distance metric, such as the Euclidian distance. In some embodiments, the distance between the cluster and unclustered items of the distance matrix is determined using a mathematical criterion, such as the nearest point algorithm.

In some embodiments, the remote computing device uses the weights in the third data structure to rebalance an asset allocation for a financial portfolio. In some embodiments, each server computing device includes a plurality of machine learning processors, each machine learning processor having a plurality of processing cores. In some embodiments, each processing core of each machine learning processor receives and processes a portion of the corresponding computation task.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A plots the sorted eigenvalues of several correlation matrices, where the condition number is the ratio between the first and last values of each line.

FIG. 1B depicts a visual representation of the relationships implied by a covariance matrix of 50×50.

FIG. 1C depicts a visual representation of a hierarchical (tree) structure.

FIG. 2 is a block diagram of a system 200 used in a computing environment for generating optimized portfolio allocation strategies.

FIGS. 3A, 3B, and 3C comprise a flow diagram of a method of generating optimized portfolio allocation strategies.

FIG. 4 is an example of encoding a correlation matrix ρ as a distance matrix D.

FIG. 5 is an example of determining of a Euclidian distance of correlation distances.

FIG. 6 is an example of clustering a pair of columns.

FIG. 7 is an example of defining the distance between an item and the newly-formed cluster.

FIG. 8 is an example of updating the matrix with the newly-formed cluster.

FIG. 9 an example of the recursion process to append further clusters to the matrix.

FIG. 10 is a graph depicting the clusters formed at each iteration of the recursion process.

FIG. 11 is an example of computer code to implement the quasi-diagonalization process.

FIG. 12 is an example of computer code to implement the recursive bisection process.

FIG. 13 depicts an exemplary correlation matrix as a heatmap.

FIG. 14 depicts an exemplary dendogram of the resulting clusters.

FIG. 15 is another representation of the correlation matrix of FIG. 13, reorganized in blocks according to the identified clusters.

FIGS. 16A-16D provide exemplary computer code for the correlation matrix and clustering processes.

FIG. 17 depicts a table with different allocations resulting from three portfolio strategies: CLA portfolio strategy, HCA portfolio strategy, and inverse-volatility portfolio strategy.

FIGS. 18A, 18B, and 18C each plots the time series of allocations for the first of the 10,000 runs for a different portfolio strategy.

FIGS. 19A-19D provide exemplary computer code that, when executed by the processor, implements the Monte Carlo analysis.

FIG. 20 is a diagram of a hardware architecture for a computerized trading system to execute a software application that uses the HRP optimal portfolio allocation to issue buy/sell orders.

FIGS. 21A and 21B are a flow diagram of a method for applying the optimized portfolio allocations generated by the HRP algorithm to issue buy/sell orders in a computerized trading system.

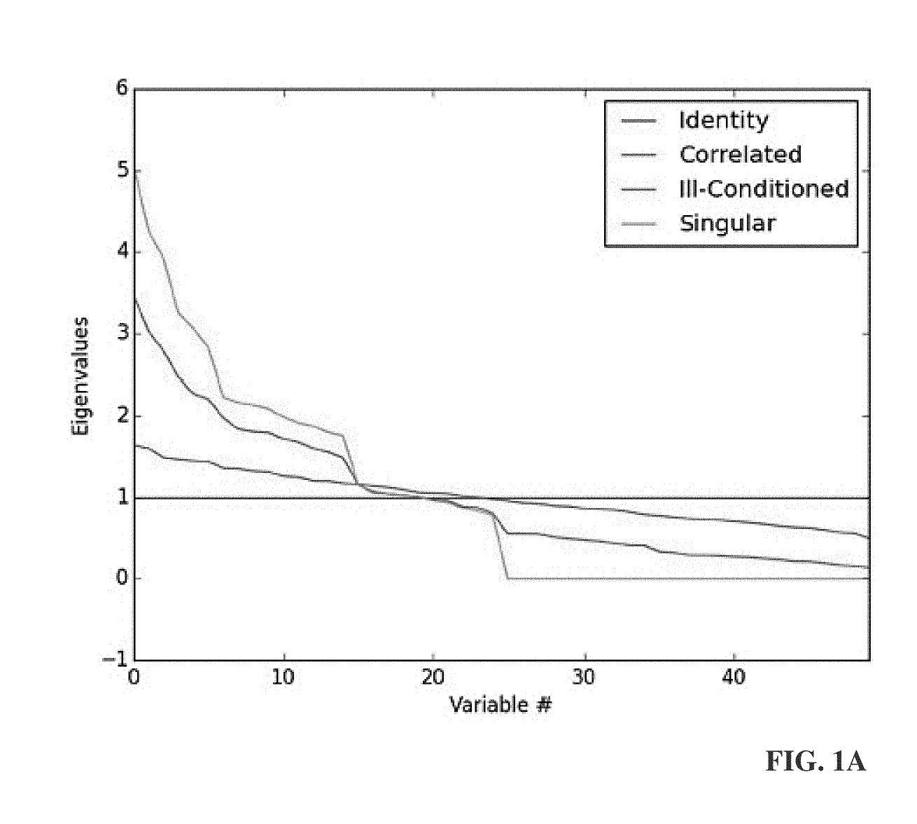

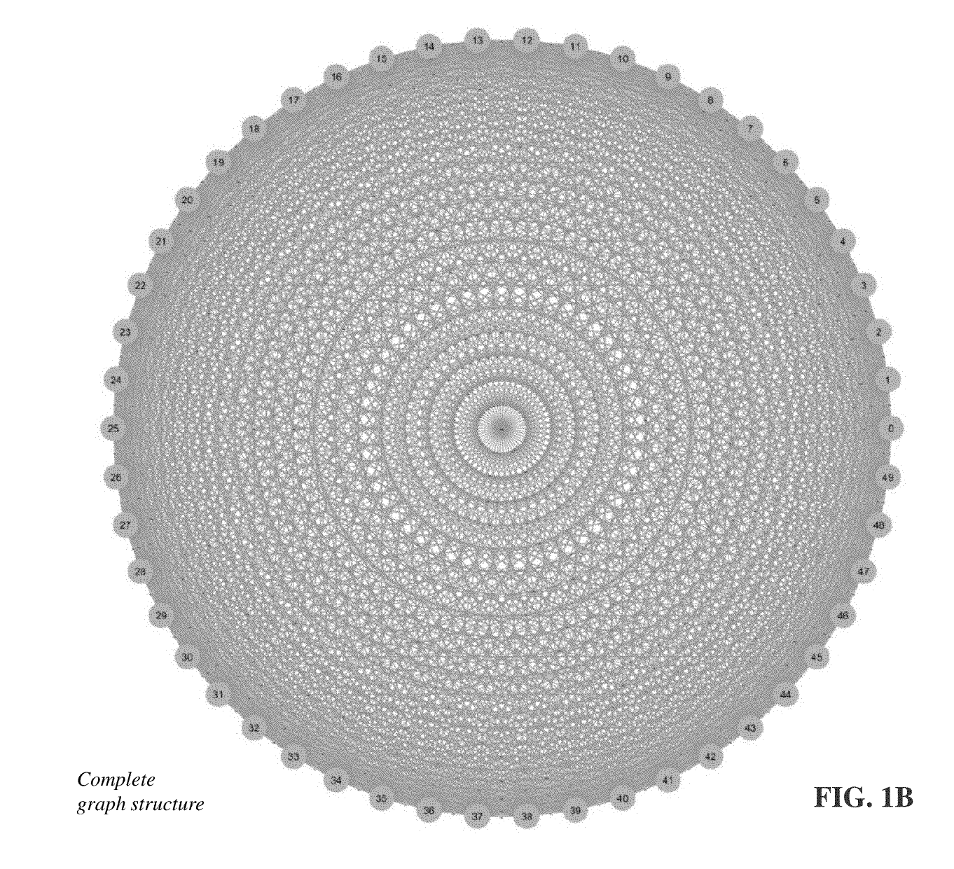

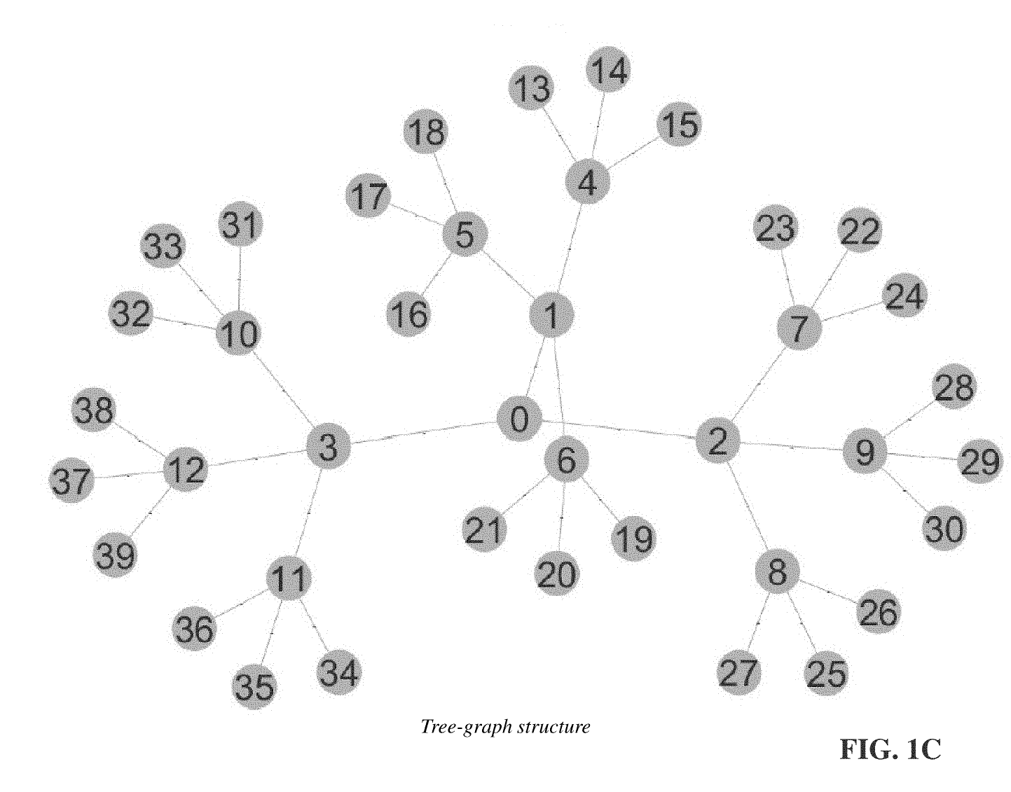

### DETAILED DESCRIPTION

The methods and systems described herein provide a computerized portfolio construction method that addresses CLA's instability issues thanks to the use of modern computer data analysis techniques: graph theory and machine learning using a cluster of computing devices operating in parallel. The Hierarchical Portfolio Construction (HRP) methodology set forth herein uses the information contained in the covariance matrix without requiring its inversion or positive-definitiveness. In fact, HRP can compute a portfolio based on a singular covariance matrix, an impossible feat for quadratic optimizers. HRP operates in three stages: tree clustering, quasi-diagonalization, and recursive bisection.

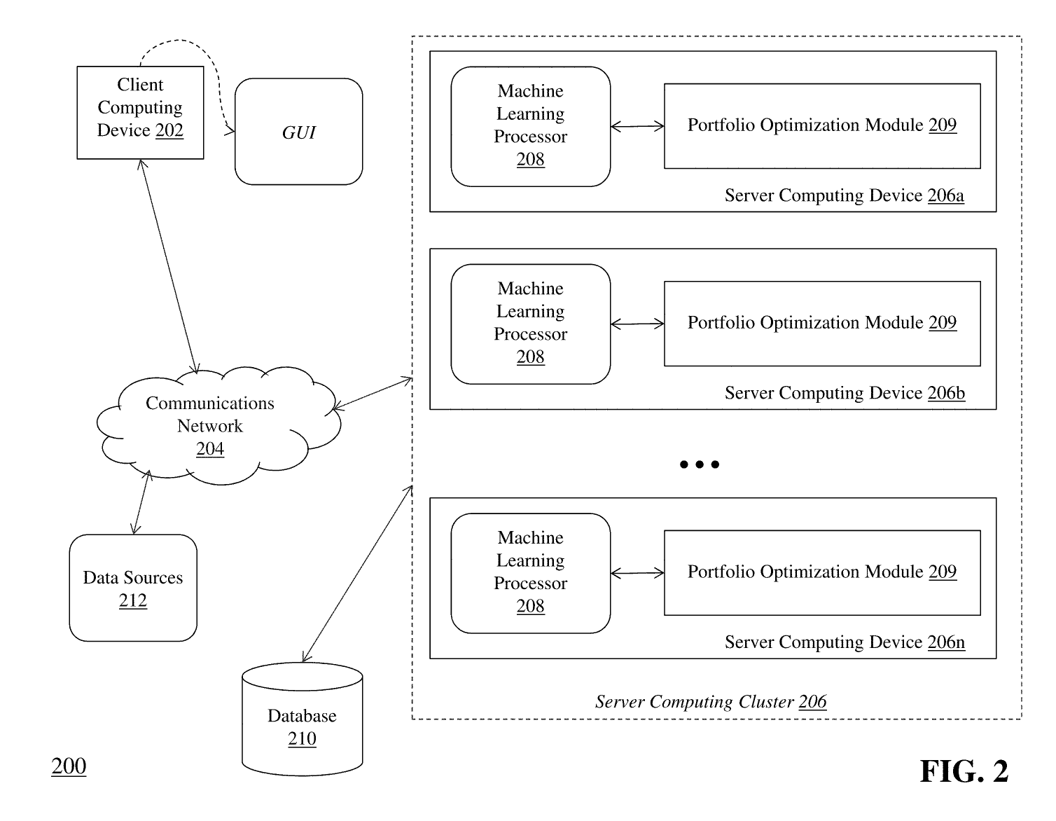

FIG. 2 is a block diagram of a system 200 used in a computing environment for generating optimized portfolio allocation strategies using a machine learning processor (e.g., processor 208). The system 200 includes a client computing device 202, a communications network 204, a plurality of server computing devices 206a-206n arranged in a server computing cluster 206, each server computing device 206a-206n having one or more specialized machine learning processors 208 that each executes a portfolio optimization module 209. The system 200 also includes a database 210 and one or more data sources 212.

The client computing device 202 connects to the communications network 204 in order to communicate with the server computing cluster 206 to provide input and receive output relating to the process of generating optimized portfolio allocation strategies using a machine learning processor as described herein. For example, client computing device 202 can be coupled to a display device that presents a detailed graphical user interface (GUI) with output resulting from the methods and processes described herein, where the GUI is utilized by an operator to review the output generated by the system. In addition, the client computing device 202 can be coupled to one or more input devices that enable an operator of the client device to provide input to the other components of the system for the purposes described herein.

Exemplary client devices 202 include but are not limited to desktop computers, laptop computers, tablets, mobile devices, smartphones, and internet appliances. It should be appreciated that other types of computing devices that are capable of connecting to the components of the system 200 can be used without departing from the scope of invention. Although FIG. 2 depicts a single client device 202, it should be appreciated that the system 200 can include any number of client devices. And as mentioned above, in some embodiments the client device 202 also includes a display for receiving data from the server computing device 206 and displaying the data to a user of the client device 202.

The communication network 204 enables the other components of the system 200 to communicate with each other in order to perform the process of generating optimized portfolio allocation strategies using a machine learning processor as described herein. The network 204 may be a local network, such as a LAN, or a wide area network, such as the Internet and/or a cellular network. In some embodiments, the network 104 is comprised of several discrete networks and/or sub-networks (e.g., cellular to Internet) that enable the components of the system 200 to communicate with each other.

Each server computing device 206a-206n in the cluster 206 is a combination of hardware, which includes one or more specialized machine learning processors 208 and one or more physical memory modules, and specialized software modules—including the portfolio optimization module 209—that execute on the machine learning processors 208 of the associated server computing device 206a-206n, to receive data from other components of the system 200, transmit data to other components of the system 200, and perform functions for generating optimized portfolio allocation strategies using a machine learning processor as described herein.

The machine learning processors 208 and the corresponding software module 209 are key components of the technology described herein, in that these components 208, 209 provide the beneficial technical improvement of enabling the system 200 to automatically process and analyze large sets of complex computer data elements using a plurality of computer-generated machine learning models to generate user-specific actionable output relating to the selection and optimization of financial portfolio asset allocation. The machine learning processors 208 executes artificial intelligence algorithms as contained within the module 209 to constantly improve the machine learning model by automatically assimilating newly-collected data elements into the model without relying on any manual intervention. In addition, the machine learning processors 208 operate in parallel on a divided input data set, which enables the rapid execution of a number of portfolio allocation algorithms and generation of a large portfolio allocation hierarchical data structure in conjunction with specifically-constructed attributes, a function that both necessitates the use of a specially-programmed microprocessor cluster and that would not be feasible to accomplish using general-purpose processors and/or manual techniques.

Each machine learning processor 208 is a microprocessor embedded in the corresponding server computing device 206 that is configured to retrieve data elements from the database 210 and the data sources 212 for the execution of the portfolio optimization module 209. Each machine learning processor 208 is programmed with instructions to execute artificial intelligence algorithms that automatically process the input and traverse computer-generated models in order to generate specialized output corresponding to the module. Each machine learning processor 208 can transmit the specialized output to downstream computing devices for analysis and execution of additional computerized actions.

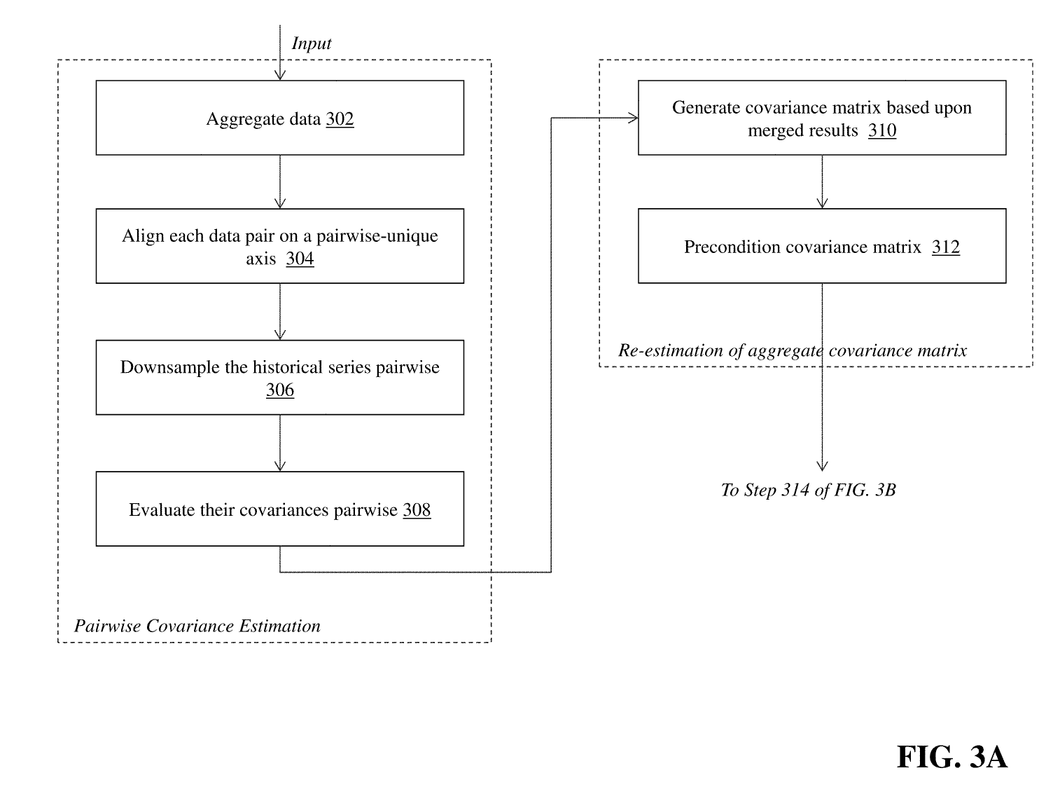

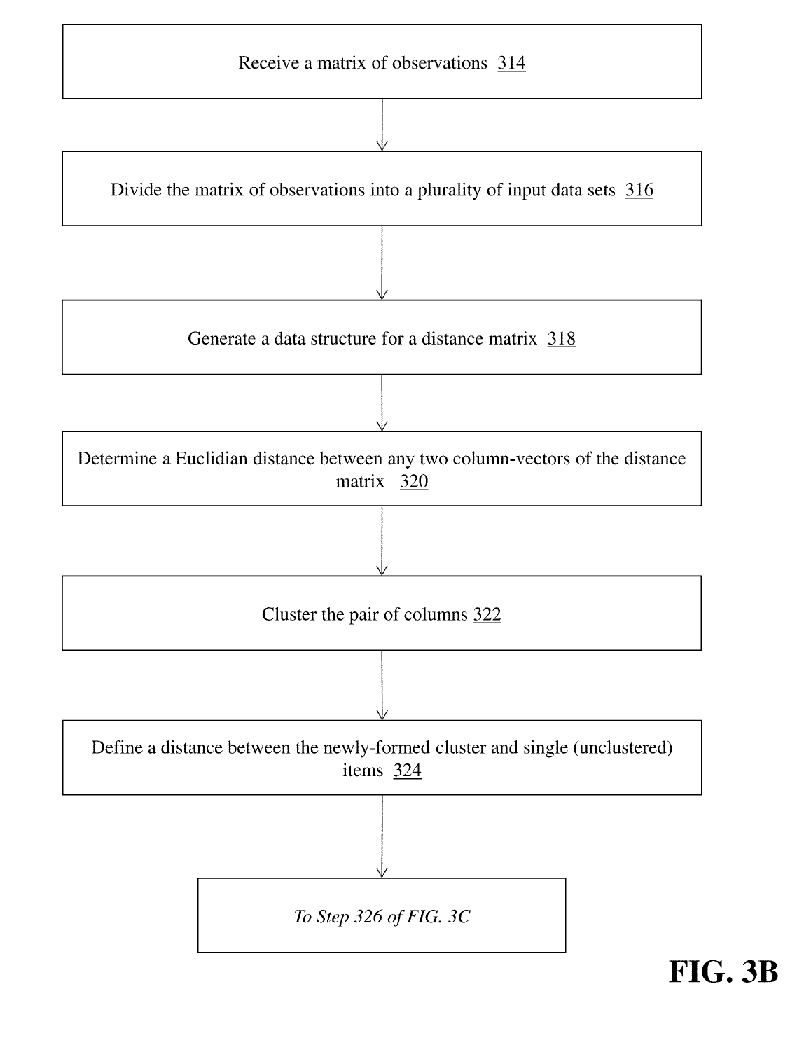

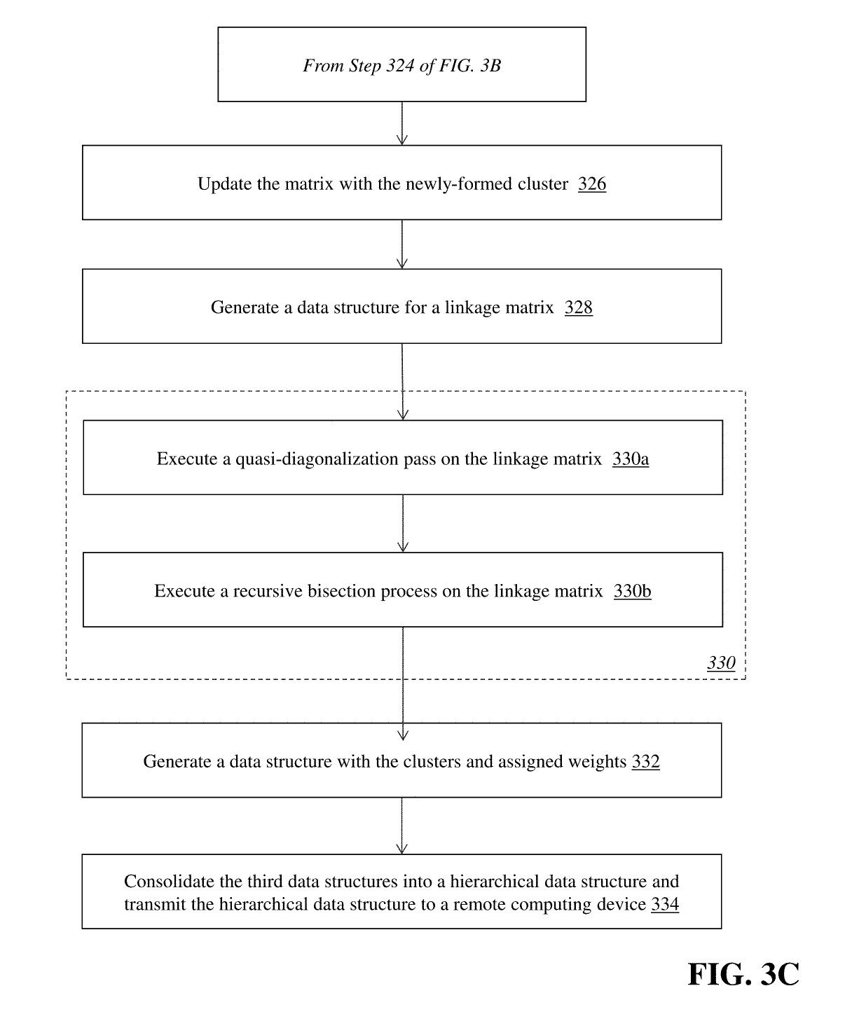

Each machine learning processor 208 executes a variety of algorithms and generates different data structures (including, in some embodiments, computer-generated models) to achieve the objectives described herein. An exemplary workflow is described further below in this description with respect to FIGS. 3A and 3B. In one example, in some embodiments, in both the model training and model operation phases, the first step performed by each machine learning processor 208 is a data preparation step that cleans the structured and unstructured data collected. Data preparation involves eliminating incomplete data elements or filling in missing values, constructing calculated variables as functions of data provided, formatting information collected to ensure consistency, data normalization or data scaling and other pre-processing tasks.

In the training phase, initial data processing may lead to a reduction of the complexity of the data set through a process of variable selection. The process is meant to identify non-redundant characteristics present in the data collected that will be used in the computer-generated analytical model. This process also helps determine which variables are meaningful in analysis and which can be ignored. It should be appreciated that by “pruning” the dataset in this manner, the system achieves significant computational efficiencies in reducing the amount of data needed to be processed and thereby effecting a corresponding reduction in computing cycles required.

In addition, in some embodiments the machine learning model includes a class of models that can be summarized as supervised learning or classification, where a training set of data is used to build a predictive model that will be used on “out of sample” or unseen data to predict the desired outcome. In one embodiment, the linear regression technique is used to predict the appropriate categorization of an asset and/or an allocation of assets based on input variables. In another embodiment, a decision tree model can be used to predict the appropriate classification of an asset and/or an allocation of assets. Clustering or cluster analysis is another technique that may be employed, which classifies data into groups based on similarity with other members of the group.

Each machine learning processor 208 can also employ non-parametric models. These models do not assume that there is a fixed and unchanging relationship between the inputs and outputs, but rather the computer-generated model automatically evolves as the data grows and more experience and feedback is applied. Certain pattern recognition models, such as the k-Nearest Neighbors algorithm, are examples of such models.

Furthermore, each machine learning processor 208 develops, tests and validates the computer-generated model described herein iteratively according to the step highlighted above. For example, each processor 208 scores each model objective function and continuously selects the model with the best outcomes.

In some embodiments, the portfolio optimization module 209 is a specialized set of artificial intelligence-based software instructions programmed onto the associated machine learning processor 208 in the server computing device 206 and can include specifically-designated memory locations and/or registers for executing the specialized computer software instructions. Further explanation of the specific processing performed by the module 209 is provided below.

The database 210 is a computing device (or in some embodiments, a set of computing devices) that is coupled to the server computing cluster 206 and is configured to receive, generate, and store specific segments of data relating to the process of generating optimized portfolio allocation strategies using a machine learning processor as described herein. In some embodiments, all or a portion of the database 210 can be integrated with the server computing device 206 or be located on a separate computing device or devices. For example, the database 210 can comprise one or more databases, such as MySQL™ available from Oracle Corp. of Redwood City, Calif.

The data sources 212 comprise a variety of databases, data feeds, and other sources that supply data to each machine learning processor 208 to be used in generating optimized portfolio allocation strategies using a machine learning processor as described herein. The data sources 212 can provide data to the server computing device according to any of a number of different schedules (e.g., real-time, daily, weekly, monthly, etc.) The specific data elements provided to the processors 208 by the data sources 212 are described in greater detail below.

Further to the above elements of system 200, it should be appreciated that the machine learning processors 208 can build and train the computer-generated model prior to conducting the processing described herein. For example, each machine learning processor 208 can retrieve relevant data elements from the database 210 and/or the data sources 212 to execute algorithms necessary to build and train the computer-generated model (e.g., input data, target attributes) and execute the corresponding artificial intelligence algorithms against the input data set to find patterns in the input data that map to the target attributes. Once the applicable computer-generated model is built and trained, the machine learning processors 208 can automatically feed new input data (e.g., an input data set) for which the target attributes are unknown into the model using, e.g., the price optimization module 209. Each machine learning processor 208 then executes the corresponding module 209 to generate predictions about how the data set maps to target attributes. Each machine learning processor 208 then creates an output set based upon the predicted target attributes. It should be appreciated that the computer-generated models described herein are specialized data structures that are traversed by the machine learning processors 208 to perform the specific functions for generating optimized portfolio allocation strategies as described herein. For example, in one embodiment, the models are a framework of assumptions expressed in a probabilistic graphical format (e.g., a vector space, a matrix, and the like) with parameters and variables of the model expressed as random components.

FIGS. 3A, 3B, and 3C comprise a flow diagram of a method of generating optimized portfolio allocation strategies, using the system 200 of FIG. 2.

### Stage 1: Tree Clustering

In one embodiment, the server computing cluster 206 generates as input a file with historical series data, in the form of prices or dollar values. For example, the server computing cluster 206 collects data from a variety of data feeds and sources (e.g., database 210, data sources 212) and consolidates the collected data into time series data (e.g., one time series per financial instrument or security) aligned in columns (e.g., one column per security) by a timestamp associated with the data. In one embodiment, the data is sampled in terms of equal volume buckets at the same speed as the market.

Using a parallelization layer, the server computing cluster 206 divides (304) the computation of pairwise covariances into a plurality of computation tasks and transmits each task to, e.g., a different machine learning processor 208 of the cluster 206. In some embodiments, each machine learning processor 208 is comprised of a plurality of processing cores (e.g., 24 cores) and the server computing cluster 206 transmits a separate task to each core of each machine learning processor. For example, if the server computing cluster 206 comprises 100 server computing devices and each processor has 24 cores, the cluster 206 is capable of dividing the tasks into 2,400 separate tasks and transmitting each task to a different core, thereby enabling the cluster 206 to process the tasks in parallel—which realizes a significant increase of processing speed and efficiency over traditional computing systems.

In some embodiments, the server computing cluster 206 processes the covariance matrix in a computationally efficient way: (i) pairwise covariance estimation and (ii) re-estimation of the aggregate covariance matrix. For pairwise covariance estimation, the cluster 206 downsamples the input historical series pairwise, to minimize the loss of data. During evaluation, the union of the timestamps is taken and each strategy forward fills. The joined series are then downsampled (e.g., 1:3 timestamps) and their covariance calculated. Evaluating the matrix elements individually has the added benefit of allowing parallel processing to enhance speed (as noted above).

FIG. 3A is a flow diagram of a method for pairwise covariance estimation and re-estimation of the aggregate covariance matrix. As noted above, the server computing cluster 206 aggregates (302) the data from a variety of feeds and sources into time series data, and aligns (304) the time series data pairs on pairwise-unique axes. The server computing cluster 206 then downsamples (306) the historical series pairwise and evaluates (308) their covariances.

An exemplary algorithm to enhance parallel processing is below:

Consider two nested loops, where the outer loop iterates i=1, . . . , N and the inner loop iterates j=1, . . . , i. We can order these atomic tasks {(i,j)|i≧j, i=1, . . . , N} as a lower triangular matrix (including the main diagonal). This entails

$$\frac{1}{2} N ( N - 1 ) + N = \frac{1}{2} N ( N + 1 )$$

operations, where

$$\frac{1}{2} N ( N - 1 )$$

are off-diagonal and N are diagonal. We would like to parallelize these tasks by partitioning the atomic tasks into M subsets of rows, {{Sₘ}_{m=1, . . . , M}, each composed of approximately

$$\frac{1}{2 M} N ( N + 1 )$$

tasks. The following algorithm determines the rows that constitute each subset.

The first subset, S₁, is composed of the first r₁ rows, i.e. S₁={1, . . . , r₁} for a total number of items

$$\frac{1}{2} {r}_{1} ( {r}_{1} + 1 ) .$$

Then, r₁ must satisfy the condition

$$\frac{1}{2} {r}_{1} ( {r}_{1} + 1 ) = \frac{1}{2 M} N ( N + 1 ) .$$

Solving for r₁, we obtain the positive root

$${r}_{1} = \frac{- 1 + \sqrt{1 + 4 N ( N + 1 ) {M}^{- 1}}}{2}$$

The second subset contains rows, S₂={r₁+1, . . . , r₂}, for a total number of items

$$\frac{1}{2} ( {r}_{2} + {r}_{1} + 1 ) ( {r}_{2} - {r}_{1} ) .$$

Then, r₂ must satisfy the condition

$$\frac{1}{2} ( {r}_{2} + {r}_{1} + 1 ) ( {r}_{2} - {r}_{1} ) = \frac{1}{2 M} N ( N + 1 ) .$$

Solving for r₂, we obtain the positive root

$${r}_{2} = \frac{- 1 + \sqrt{1 + 4 ( {r}_{1}^{2} + {r}_{1} + N ( N + 1 ) {M}^{- 1} )}}{2}$$

We can repeat the same argument for a future subset Sₘ={rₘ₋₁+1, . . . , rₘ}, with a total number of items

$$\frac{1}{2} ( {r}_{m} + {r}_{m - 1} + 1 ) ( {r}_{m} - {r}_{m - 1} ) .$$

Then, rₘ must satisfy the condition

$$\frac{1}{2} ( {r}_{m} + {r}_{m - 1} + 1 ) ( {r}_{m} - {r}_{m - 1} ) = \frac{1}{2 M} N ( N + 1 ) .$$

Solving for rₘ, we obtain the positive root

$${r}_{m} = \frac{- 1 + \sqrt{1 + 4 ( {r}_{m - 1}^{2} + {r}_{m - 1} + N ( N + 1 ) {M}^{- 1} )}}{2}$$

And it is easy to see that rₘ reduces to r₁ for r₀=0. Because row numbers are integers, the above results are rounded to the nearest natural number. This may mean that some partitions' sizes may deviate from the

$$\frac{1}{2 M} N ( N + 1 )$$

target.

If the outer loop iterates i=1, . . . , N and the inner loop iterates j=i, . . . , N, we can order these atomic tasks {(i,j)|i≧j, i=1, . . . , N} as an upper triangular matrix (including the main diagonal). In this case, the argument upperTriang=True must be passed.

Below is an example code for the function:

#------------------------------------------------------------------------------
def nestedParts(numAtoms,numThreads,upperTriang=False):

# partition of atoms with an inner loop
parts,numThreads_=[0],min(numThreads,numAtoms)
for num in xrange(numThreads_):

part=1+4*(parts[−1]**2+parts[−1]+numAtoms*(numAtoms+1.)/numThreads_)
part=(−1+part**.5)/2.
parts.append(part)

parts=np.round(parts).astype(int)
if upperTriang: # the first rows are the heaviest

parts=np.cumsum(np.diff(parts)[::−1])
parts=np.append(np.array([0]),parts)

return parts

Then, as noted above, the server computing cluster 206 further performs re-estimation of the aggregate covariance matrix. Turning back to FIG. 3A, the server computing cluster 206 creates (310) the covariance matrix and the covariance matrix is evaluated for robustness. By performing the pairwise processing, the covariance matrix loses its assurance of positive semi-definiteness. To regain that, we evaluate the smallest eigenvalue, λ. If λ<0, we subtract λI from the covariance matrix, where I is the identity matrix. The server computing cluster 206 preconditions (312) the covariance matrix; if desired, a shrinkage estimate of the covariance matrix can be obtained via Ledoit Wolf, thereby increasing robustness of the covariance estimate. Then, the HRP algorithm (described below) is applied to the covariance matrix to determine optimal allocations to the underlying strategies in the portfolio.

Turning to FIG. 3B, the server computing cluster 206 receives (314) a T×N matrix of observations X, such as returns series of N variables over T periods, and divides (316) the matrix of observations into a plurality of computation tasks to transmit each task to, e.g., a different machine learning processor 208 of the cluster 206 (as described above). Each machine learning processor 208 executes the corresponding portfolio optimization module 209 to combine the N items (column-vectors) of the matrix into a hierarchical structure of clusters, so that allocations can flow downstream through a tree graph.

First, each machine learning processor 208 executes the corresponding portfolio optimization module 209 to generate a data structure for a N×N correlation matrix with entries

ρ={ρ_{i,j}}_{i,j=1, . . . ,N}, where ρ_{i,j}=ρ[Xᵢ,Xⱼ].

The distance measure is defined as

$$d \text{:} ( {X}_{i} , {X}_{j} ) ⋐ B \to ∈ [ 0 , 1 ] , {d}_{i , j} = d [ {X}_{i} , {X}_{j} ] = \sqrt{\frac{1}{2} ( 1 - {ρ}_{i , j} )} ,$$

where B is the Cartesian product of items in {1, . . . i, . . . , N}. This allows each machine learning processor 208 to generate (318) a data structure for a N×N distance matrix D={d_{i,j}}_{i,j=1, . . . , N}. Matrix D is a proper metric, in the sense that d[X, Y]≧0 (non-negativity), d[X, Y]=0 [symbol] X=Y (coincidence), d[X, Y]=d[Y, X] (symmetry), and d[X, Z]≦d[X, Y]+d[Y, Z] (sub-additivity).

The metric S[X, Y] could be defined as the Pearson correlation between any two vectors X and Y, that is S[X, Y]=ρ[X, Y], −1<S[X, Y]≦1. The following is a proof that

$$d [ X , Y ] = \sqrt{\frac{1}{2} ( 1 - \vert ρ [ X , Y ] \vert )}$$

is a true metric.

First, consider the Euclidian distance of two vectors d[X, Y]=\sqrt{Σₜ₌₁^{T}(Xₜ−Yₜ)²}. Second, the vectors are z-standardized and rotated as

$$x = \frac{X - \overline{X}}{σ [ X ]} , y = \frac{Y - \overline{Y}}{σ [ Y ]} .$$

Consequently, 0≦ρ[X, Y]=|ρ[X, Y]|. Third, the Euclidian distance d[x, y] is derived as:

$$\begin{matrix}d [ x , y ] = \sqrt{{\sum }_{t = 1}^{T} {( {x}_{t} - {y}_{t} )}^{2}} \\ = \sqrt{{\sum }_{t = 1}^{T} {x}_{t}^{2} + {\sum }_{t = 1}^{T} {y}_{t}^{2} - 2 {\sum }_{t = 1}^{T} {x}_{t} {y}_{t}} \\ = \sqrt{T + T - 2 T σ [ x , y ]} \\ = \sqrt{2 T ( 1 - \underbrace{ρ [ x , y ]}_{= \vert ρ [ X , Y ] \vert} )} \\ = \sqrt{2 T} \tilde{d} [ X , Y ]\end{matrix}$$

In other words,

$$d [ X , Y ] = \frac{1}{\sqrt{2 T}} d [ x , y ] ,$$

a linear multiple of the Euclidian distance between the vectors after z-standardization, hence it inherits the true-metric properties of the Euclidian distance.

Similarly, we can prove that d[X, Y]=\sqrt{1−|ρ[X, Y]|} is also a true metric. In order to do that, we redefine

$$y = \frac{Y - \overline{Y}}{σ [ Y ]} sgn [ ρ [ X , Y ] ] ,$$

where sgn[.] is the sign operator, so that 0≦β[x, y]=|ρ[X, Y]|. Then,

$$d [ x , y ] = \sqrt{2 T ( 1 - \underbrace{ρ [ x , y ]}_{= \vert ρ [ X , Y ] \vert} )} = \sqrt{2 T} d [ X , Y ]$$

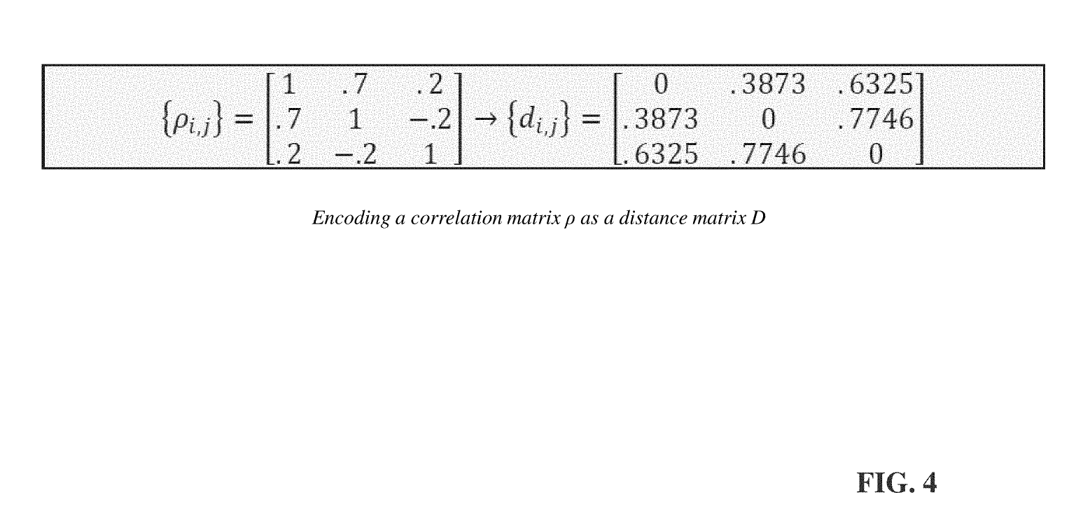

FIG. 4 is an example of encoding a correlation matrix ρ as a distance matrix D as executed by each machine learning processor 208 and the corresponding portfolio optimization module 209.

Next, each machine learning processor 208 executes the portfolio optimization module 209 to determine (320) the Euclidian distance between any two column-vectors of D,

\tilde{d}:(Dᵢ,Dⱼ)⊂B→ [symbol] ε[0,\sqrt{N}],

\tilde{d}_{i,j}=\tilde{d}[Dᵢ,Dⱼ]=\sqrt{Σₙ₌₁^{N}(d_{n,i}−d_{n,j})²}.

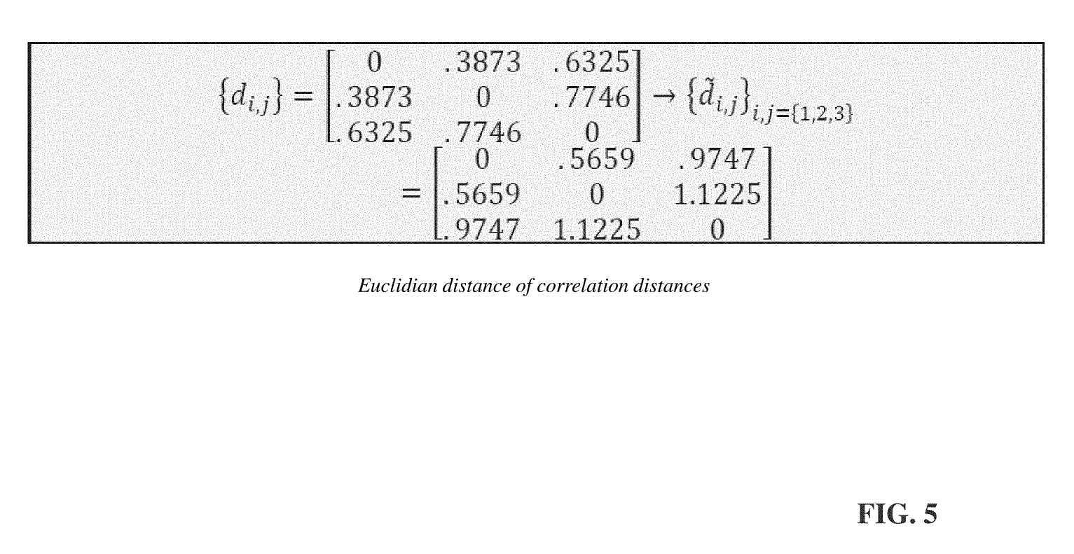

Note the difference between distance metrics d_{i,j} and \tilde{d}_{i,j}. Whereas d_{i,j} is defined on column-vectors of X, \tilde{d}_{i,j} is defined on column-vectors of D (a distance of distances). Therefore, \tilde{d} is a distance defined over the entire metric space D, as each \tilde{d}_{i,j} is a function of the whole correlation matrix (rather than a particular cross-correlation pair). FIG. 5 is an example of determining a Euclidian distance of correlation distances as executed by the machine learning processor 208 and the portfolio optimization module 209.

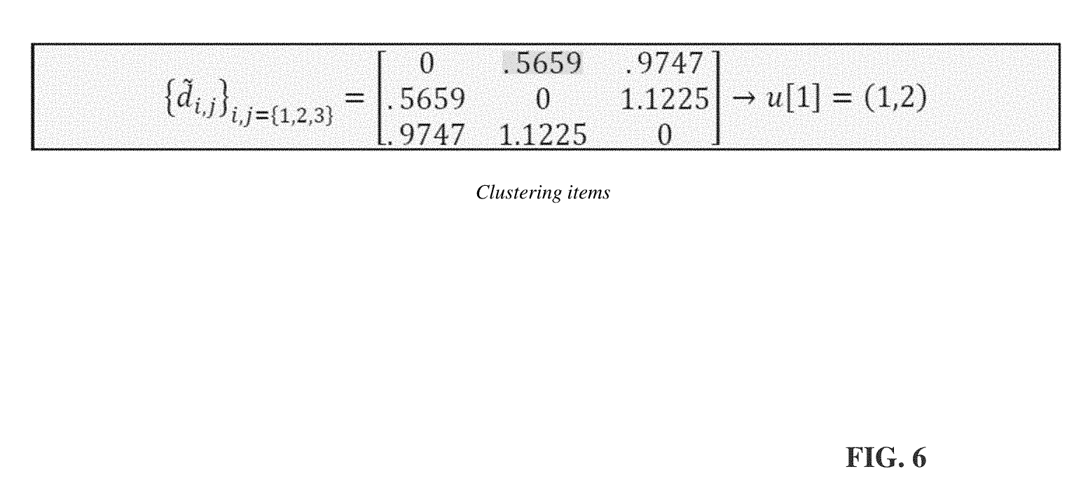

Each machine learning processor 208 then executes the corresponding portfolio optimization module 209 to cluster (322) together the pair of columns (i*,j*) such that (i*,j*)=argmin_{(i,j)}_{_{i≠j}}{\tilde{d}_{i,j}}. The cluster is denoted as u[1]. FIG. 6 is an example of clustering a pair of columns as executed by each machine learning processor 208 and the corresponding portfolio optimization module 209.

Next, the machine learning processor 208 executes the corresponding portfolio optimization module 209 to define (324) the distance between a newly-formed cluster u[1] and the single (unclustered) items, so that {\tilde{d}_{i,j}} may be updated. In hierarchical clustering analysis, this is known as the “linkage criterion.” For example, the machine learning processor 208 can define the distance between an item i of \tilde{d} and the new cluster u[1] as

\dot{d}_{i,u[1]}=min [{\tilde{d}_{i,j}}_{jεu[1]}] (the nearest point algorithm).

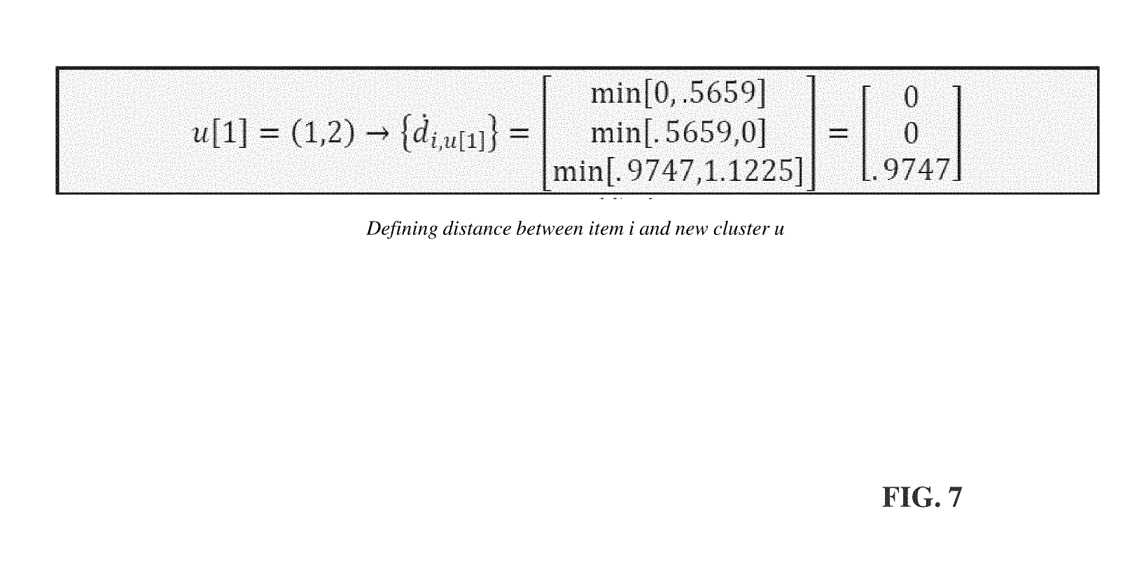

FIG. 7 is an example of defining the distance between an item and the new cluster as executed by the machine learning processor 208 and the corresponding portfolio optimization module 209.

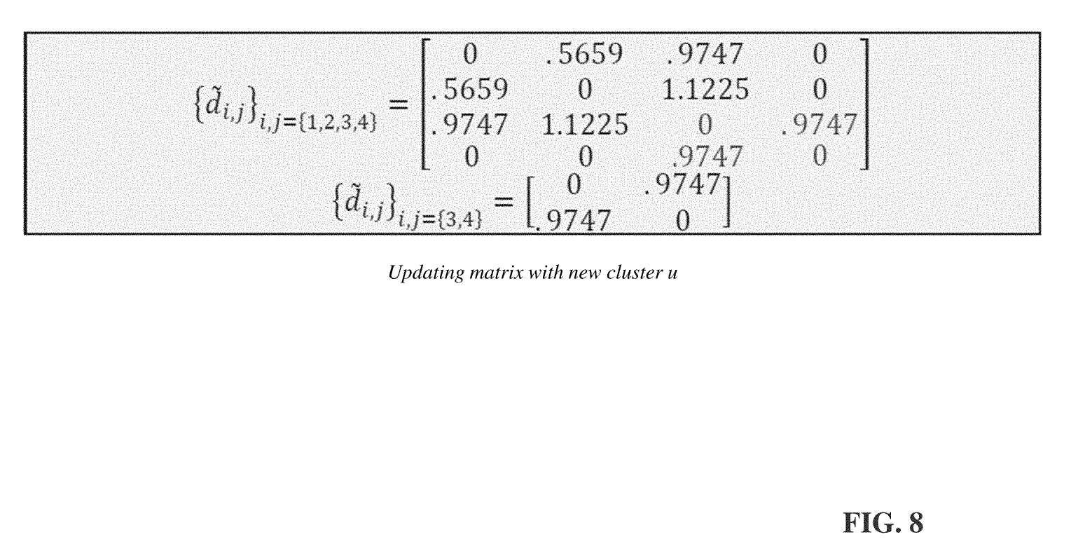

Turning to FIG. 3C, each machine learning processor 208 executes the corresponding portfolio optimization module 209 to update (326) the matrix {\tilde{d}_{i,j}} by appending \dot{d}_{i,u[1]} and dropping the clustered columns and rows j Σ u[1]. FIG. 8 is an example of updating the matrix {\tilde{d}_{i,j}} in this way.

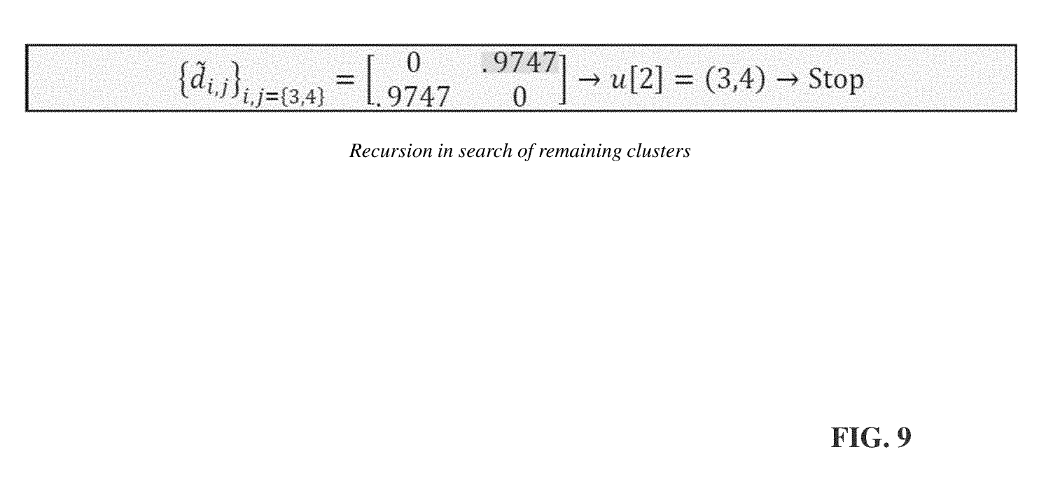

Next, each machine learning processor 208 executes the corresponding portfolio optimization module 209 to recursively apply steps 322, 324, and 326 in order to append N−1 such clusters to matrix D, at which point the final cluster contains all of the original items and the machine learning processor 208 stops the recursion process. FIG. 9 is an example of the recursion process as executed by the machine learning processor 208 and the corresponding portfolio optimization module 209.

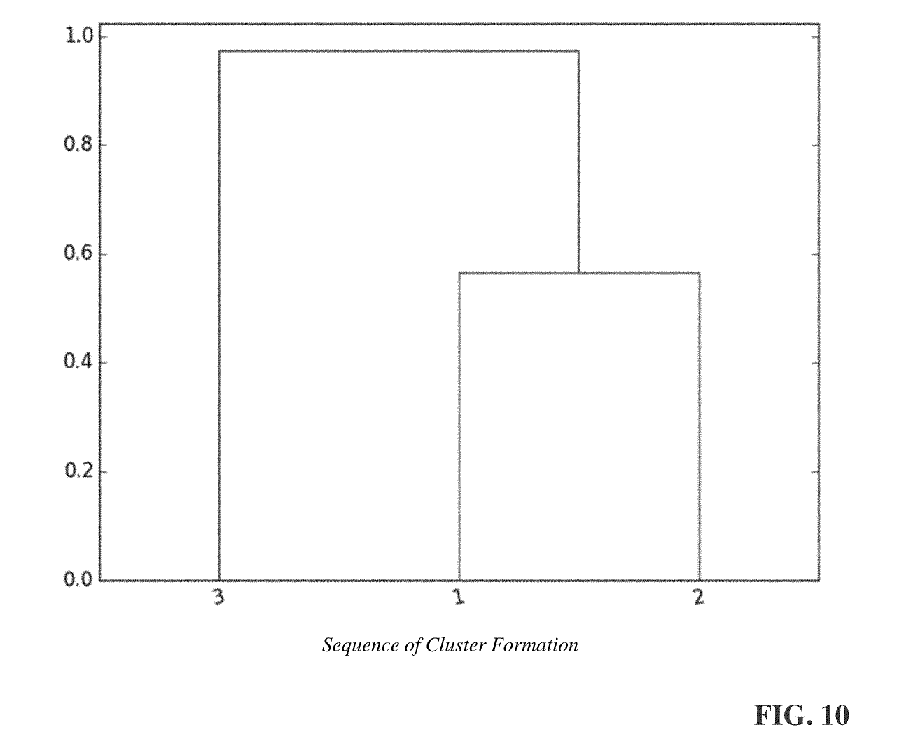

FIG. 10 is a graph depicting the clusters formed at each iteration of the recursive process, as well as the distances \tilde{d}_{i*,j*} that triggered every cluster (i.e., step 320 of FIG. 3B). This procedure can be applied to a wide array of distance metrics d_{i,j}, \tilde{d}_{i,j} and \dot{d}_{i,u}, beyond those described in this application. As an example, see Rokach, L. and O. Maimon, “Clustering methods,” in Data mining and knowledge discovery handbook, Springer, U.S. (2005), pp. 321-352 for alternative metrics (which is incorporated herein by reference), the discussion on Fiedler's vector and Stewart's spectral clustering method as described in Brualdi, R., “The Mutually Beneficial Relationship of Graphs and Matrices,” Conference Board of the Mathematical Sciences, Regional Conference Series in Mathematics, Nr. 115 (201) (which is incorporated herein by reference), as well as algorithms in the scipy library, which are available at
http://docs.scipy.org/doc/scipy/reference/generated/scipy.spatial.distance.pdist.html
   and
http://docs.scipy.org/doc/scipy-0.16.0/reference/generated/scipy.cluster.hierarchy.linkage.html.

Each machine learning processor 208 then generates (328) a data structure for a linkage matrix as a (N−1)×4 matrix with structure

Y={(y_{m,1}y_{m,2}y_{m,3},y_{m,4})}_{m=1, . . . ,N-1}

i.e. with one 4-tuple per cluster. Items (y_{m,1}, y_{m,2}) report the cluster constituents. Item y_{m,a} reports the distance between y_{m,1} and y_{m,2}, that is y_{m,a}=\tilde{d}_{y}_{_{m,1}}_{y}_{_{m,2}}. Item y_{m,a}≦N reports the number of original items included in cluster m.

### Stage 2: Quasi-Diagonalization

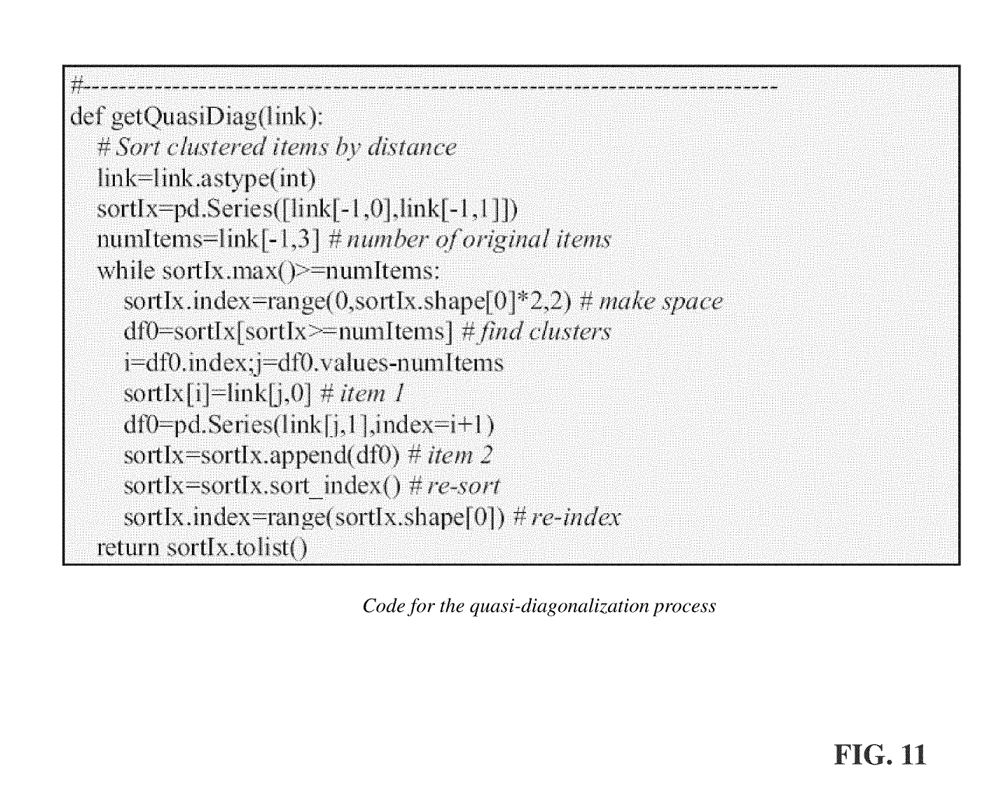

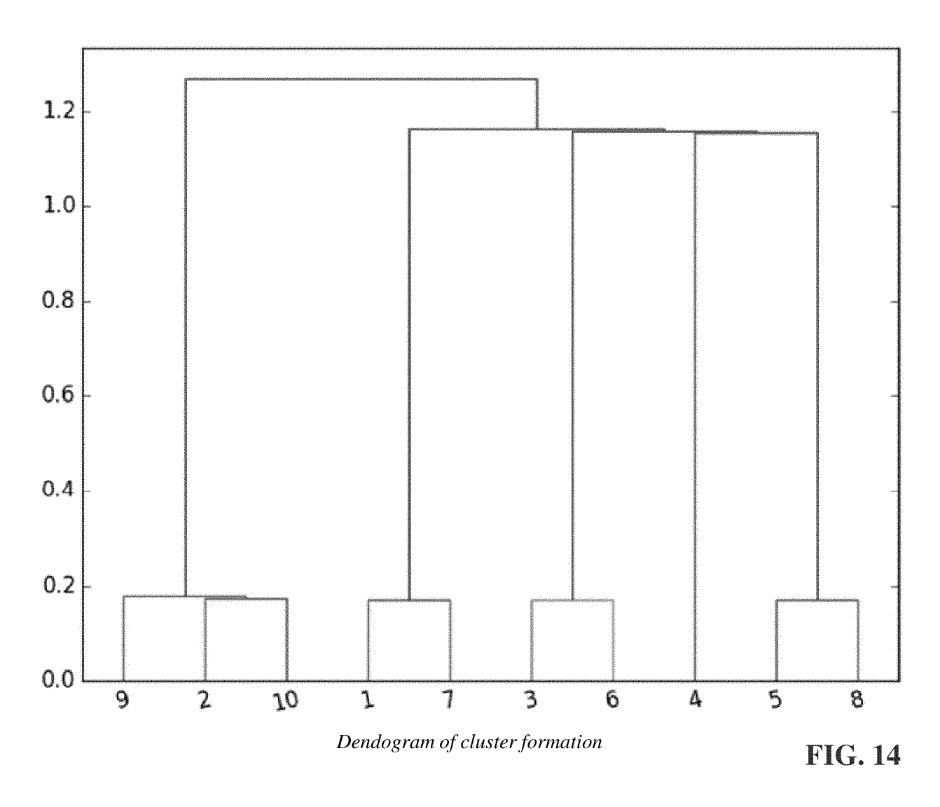

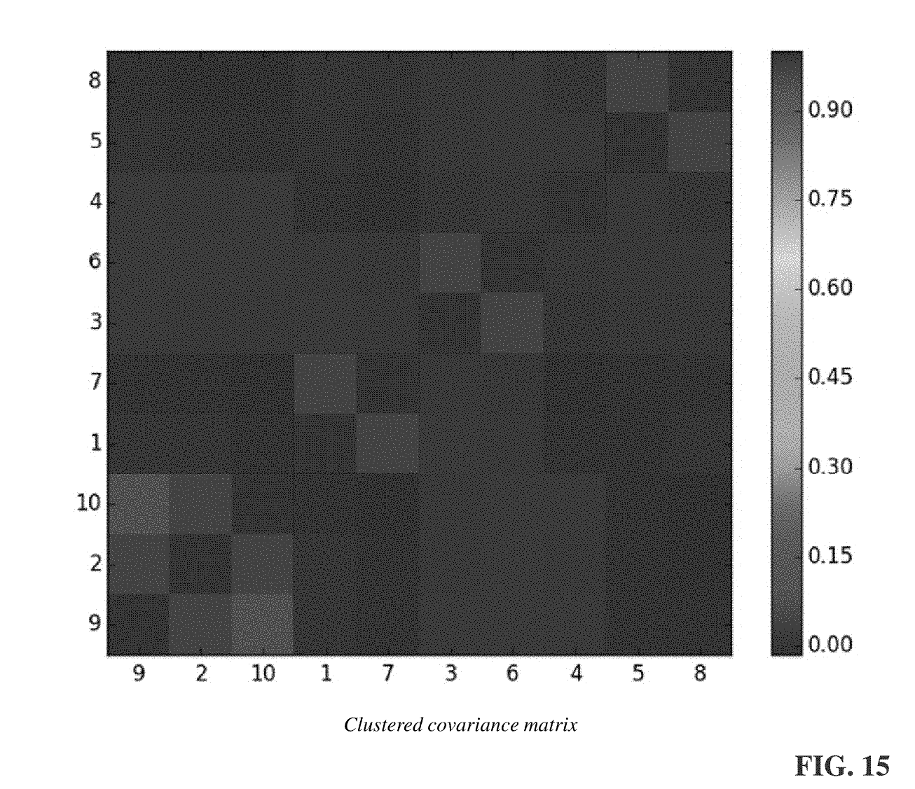

The machine learning processor 208 executes (330a) a quasi-diagonalization process on the linkage matrix which reorganizes the rows and columns of the covariance matrix so that the largest values lie along the diagonal. This quasi-diagonalization of the covariance matrix (without requiring a change of basis) renders a useful property: Similar investments are placed together, and dissimilar investments are placed far apart (see FIGS. 14-15 as described below for an example). The machine learning processor 208 executes a process as follows: each row of the linkage matrix merges two branches into one. The processor 208 replaces clusters in (y_{N-1,1}, y_{N-1,2}) with their constituents recursively, until no clusters remain. These replacements preserve the order of the clustering. The output from the processor 208 is a sorted list of original (unclustered) items. FIG. 11 is an example of computer code to implement the quasi-diagonalization process on the machine learning processor 208.

### Stage 3: Recursive Bisection

As noted above, the machine learning processor 208 has generated a quasi-diagonal matrix. The inverse-variance allocation is optimal for a diagonal covariance matrix. For example, this stage splits a weight in inverse proportion to the subset's variance. The following is a proof that such allocation is optimal when the covariance matrix is diagonal. Consider the standard quadratic optimization problem of size N,

$${min}_{ω} {ω}^{′} V ω$$

$$s . t . \text{:} {ω}^{′} α = {1}_{I}$$

with solution

$$ω = \frac{{V}^{- 1} α}{{α}^{′} {V}^{- 1} α} .$$

For the characteristic vector α=1_{N}, the solution is the minimum variance portfolio. If V is diagonal,

$${ω}_{n} = \frac{{V}_{n , n}^{- 1}}{{\sum }_{i = 1}^{N} {V}_{i , i}^{- 1}} .$$

In the particular case of

$$N = 2 , {ω}_{1} = \frac{\frac{1}{{V}_{1 , 1}}}{\frac{1}{{V}_{1 , 1}} + \frac{1}{{V}_{2 , 2}}} = 1 - \frac{{V}_{1 , 1}}{{V}_{1 , 1} + {V}_{2 , 2}} ,$$

which is how stage 3 splits a weight between two bisections of a subset.

The machine learning processor 208 can take advantage of these facts in two different ways: a) bottom-up, to define the variance of a continuous subset as the variance of an inverse-variance allocation; b) top-down, to split allocations between adjacent subsets in inverse proportion to their aggregated variances. The processor 208 executes (330b) a recursive bisection process on the matrix as follows:

1. The processor 208 initializes by
a. setting the list of items: L={L₀}, with L₀={n}_{n=1, . . . , N}
b. assigning a unit weight to all items: wₙ=1, ∀n=1, . . . , N

2. The processor 208 determines if |Lᵢ=1, ∀Lᵢ ε L. If true, then stop.

3. For each Lᵢ Σ L such that |Lᵢ|>1:
a. bisect Lᵢ into two subsets, Lᵢ⁽¹⁾∪Lᵢ⁽²⁾=Lᵢ, where

$$\vert {L}_{i}^{( 1 )} \vert = int [ \frac{1}{2} \vert {L}_{i} \vert ] ,$$

and the order is preserved
b. define the variance of Lᵢ^{(j)}, j=1, 2, as the quadratic form \tilde{V}ᵢ^{(j)}≡\tilde{w}ᵢ^{(j)′}Vᵢ^{(j)}\tilde{w}ᵢ^{(j)}, where Vᵢ^{(j)} is the covariance matrix between the constituents of the Lᵢ^{(j)} bisection, and

$${\tilde{w}}_{i}^{( i )} = {diag [ {V}_{i}^{( j )} ]}^{- 1} \frac{1}{tr [ {diag [ {V}_{i}^{( j )} ]}^{- 1}} ,$$

where diag[.] and tr[.] are the diagonal and trace operators
c. compute the split factor:

$${α}_{i} = 1 - \frac{{\tilde{v}}_{i}^{( 1 )}}{{\tilde{v}}_{i}^{( 1 )} + {\tilde{v}}_{i}^{( 2 )}} ,$$

so that 0≦αᵢ≦1
d. re-scale allocations wₙ by a factor of αᵢ, ∀n ε Lᵢ⁽¹⁾
e. re-scale allocations wₙ by a factor of (1−αᵢ), ∀n ε Lᵢ⁽²⁾

4. Loop to step 2.

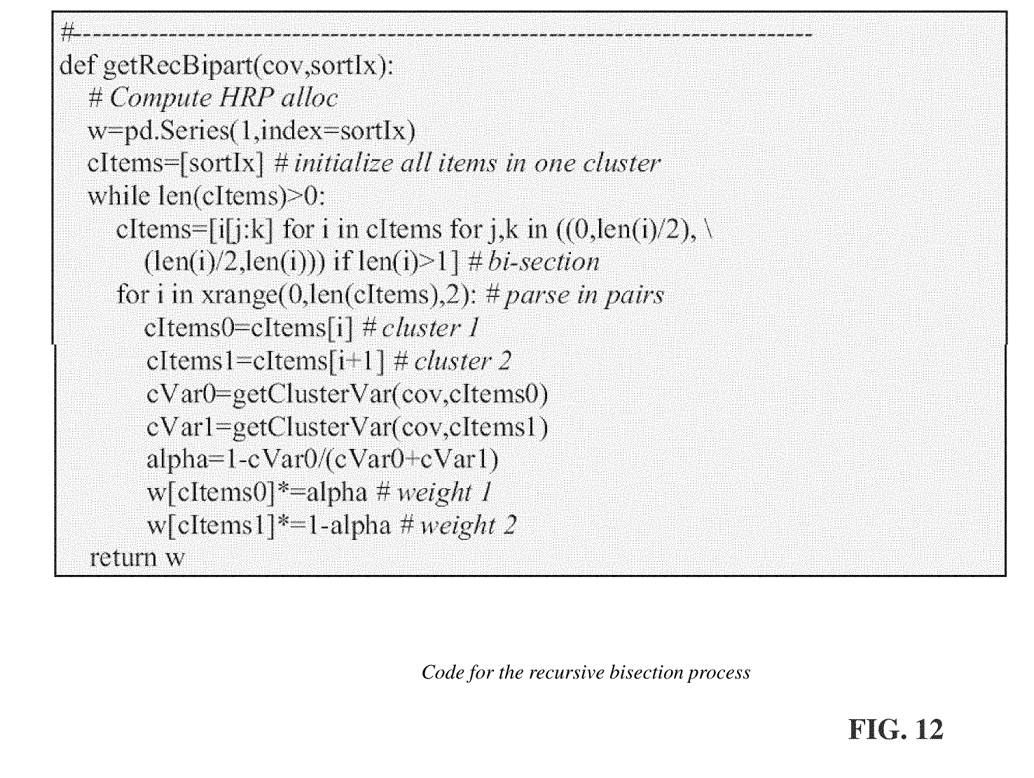

As shown above, step 3b takes advantage of the quasi-diagonalization bottom-up, because it defines the variance of the partition Lᵢ^{(j)} using inverse-variance weightings \tilde{w}ᵢ^{(j)}. Step 3c takes advantage of the quasi-diagonalization top-down, because it splits the weight in inverse proportion to the cluster's variance. The process guarantees that 0≦wᵢ≦1, ∀i=1, . . . , N, and Σᵢ₌₁^{N}wᵢ=1 because at each iteration the processor 208 is splitting the weights received from higher hierarchical levels. Constraints can be easily introduced in this stage, by replacing the equations in steps 3c-3e according to the user's preferences. FIG. 12 is an example of computer code to implement the recursive bisection process on the machine learning processor 208. The above three-stage process solves the allocation problem in deterministic logarithmic time, T(n)=0(log₂n).

Once the two passes are complete, each machine learning processor 208 generates (332) a data structure containing the clusters and the assigned weights. The server computing cluster 206 then consolidates (334) the data structures containing the clusters and the assigned weights from each machine learning processor into a hierarchical data structure representing the complete analysis described above, and transmits the hierarchical data structure to a remote computing device (e.g., for rebalancing of asset allocation in a financial portfolio).

### A Numerical Example

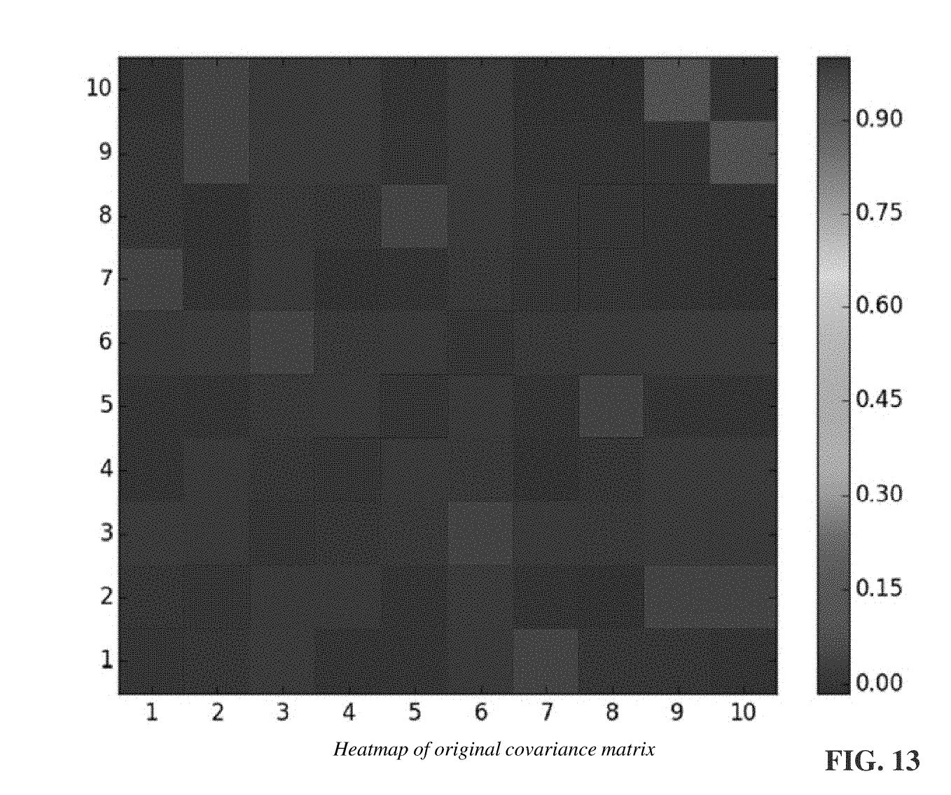

The following is an exemplary numerical use case for executing the process described above with respect to FIGS. 3A, 3B, and 3C to generate optimized portfolio allocation strategies using the system 200 of FIG. 2. As described previously, each machine learning processor 208 simulates a matrix of observations X, of order (100000x10). The correlation matrix is depicted in FIG. 13 as a heatmap. As shown in FIG. 13, the red squares denote positive correlations and the blue squares denote negative correlations. This correlation matrix has been computed on random series X={Xᵢ}_{i=1, . . . , 10} drawn as follows. First, five random vectors are drawn from a standard Normal distribution, {Xⱼ=z}_{j=1, . . . ,5}. Second, five random integer numbers are drawn from a uniform distribution, with replacement, ∂={∂ₖ}_{k=1, . . . , 5}. Third,

$${X}_{5 + k} = {X}_{{ϑ}_{k}} + \frac{1}{4} Z , ∀ k = 1 , … , 5$$

is computed. This forces the five last columns to be partially correlated to some of the first five series.

FIG. 14 depicts an exemplary dendogram of the resulting clusters (stage 1). As shown in FIG. 14, this clustering procedure has correctly identified that series 9 and 10 were perturbations of series 2, hence are clustered together. Similarly, series 7 is a perturbation of series 1, series 6 is a perturbation of series 3, and series 8 is a perturbation of series 5. The only original item that was not perturbated is series 4, and that is the one item for which the clustering algorithm found no similarity.

FIG. 15 is another representation of the correlation matrix of FIG. 13, reorganized in blocks according to the identified clusters (stage 2). Stage 2 quasi-diagonalizes the correlation matrix, in the sense that the largest values lie along the diagonal. However, unlike PCA or similar procedures, HRP does not require a change of basis. HRP solves the allocation problem robustly, while working with the original investments.

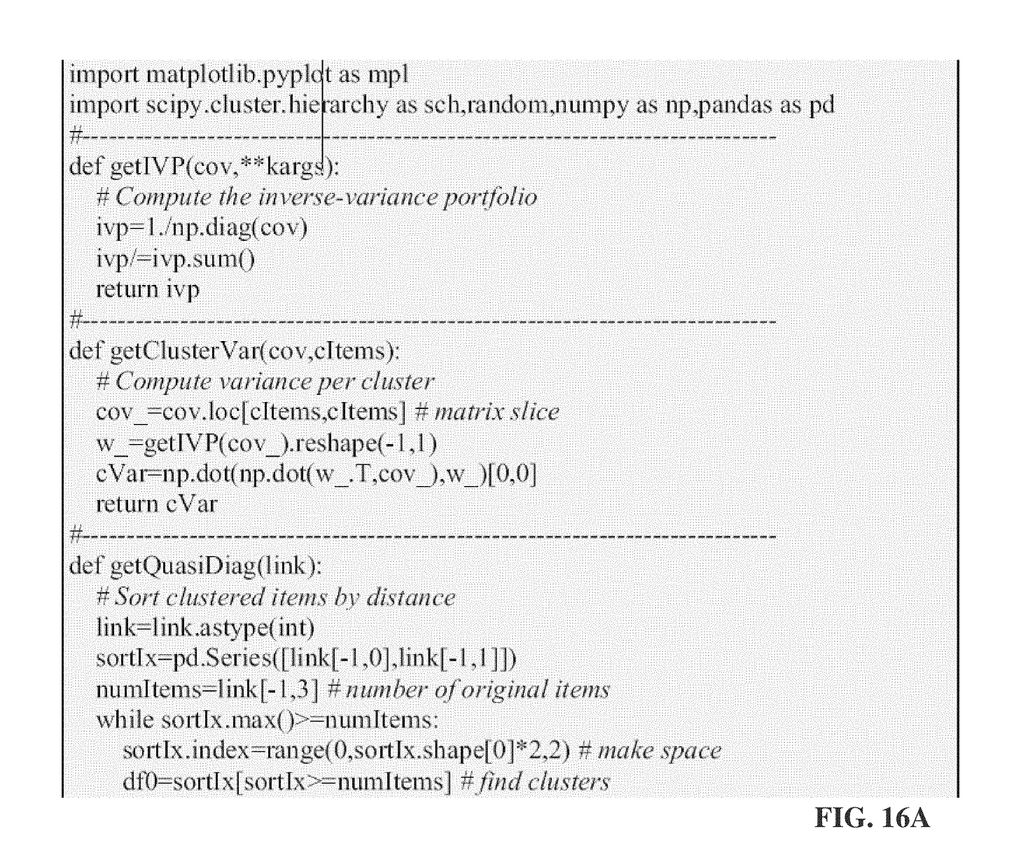

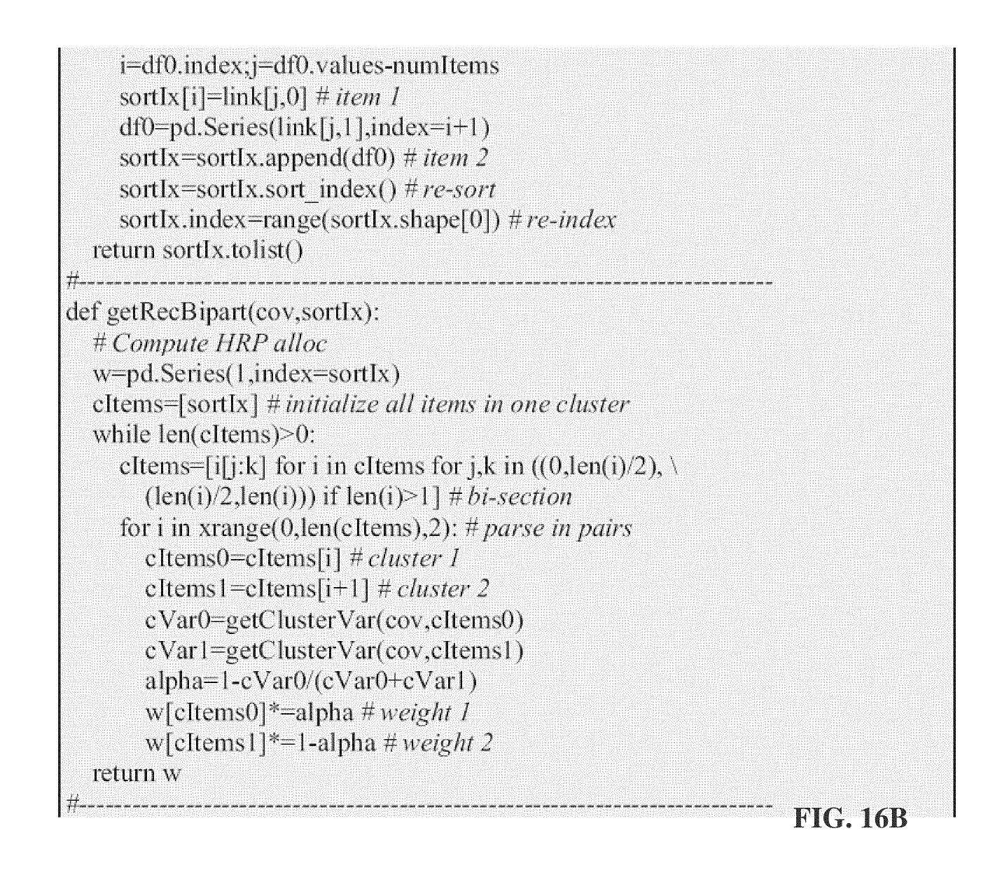

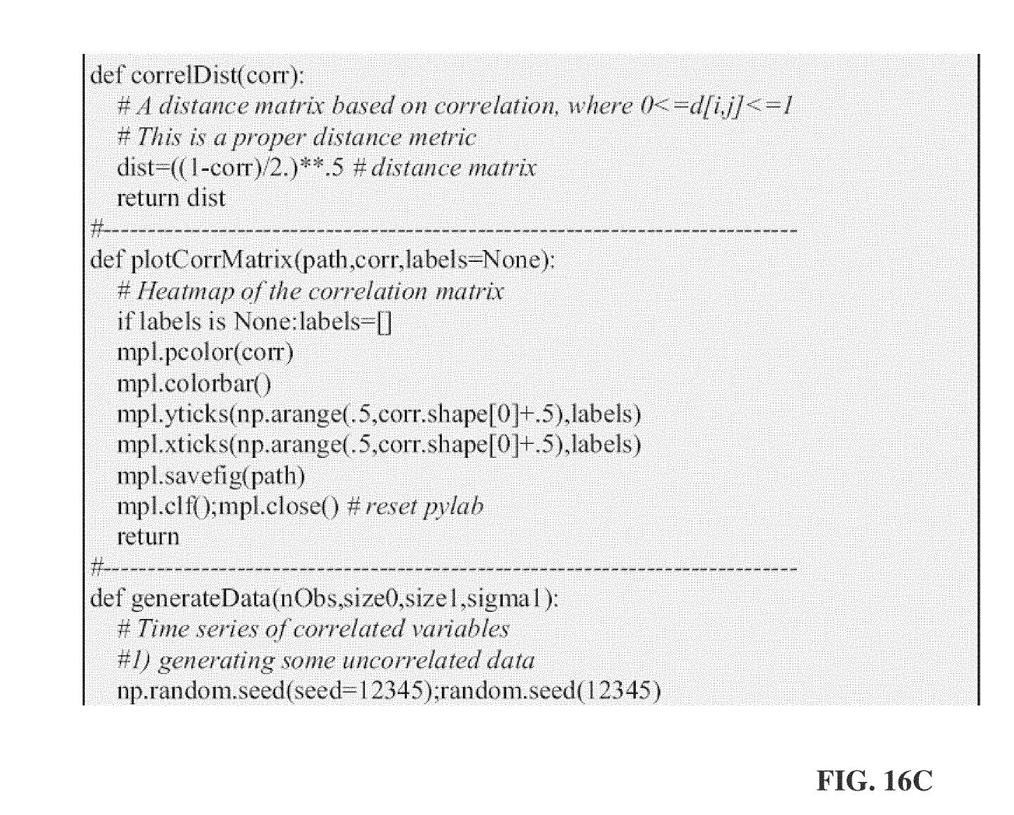

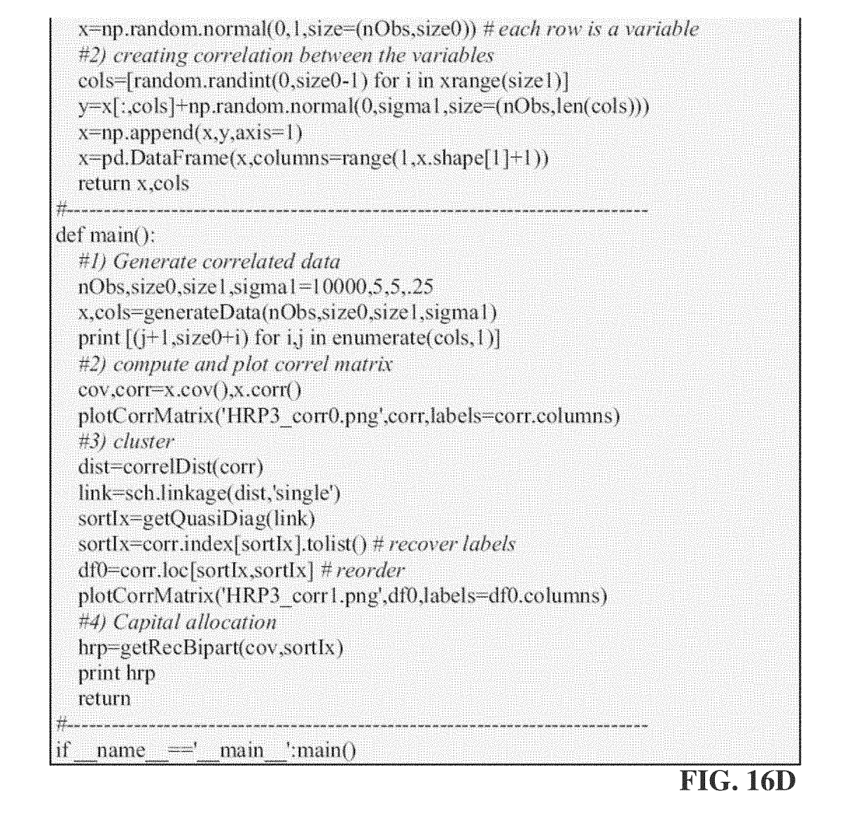

FIGS. 16A-16D provide exemplary computer code that, when executed by the machine learning processor 208, generates the numerical example described herein. As shown in FIGS. 16A-16D, function generateData( ) produces a matrix of time series where a number size0 of vectors are uncorrelated, and a number size1 of vectors are correlated. The np.random.seed in generateData( ) can be changed to run alternative examples and understand how HRP works. Scipy's function linkage( ) can be used to perform stage 1, function getQuasiDiag( ) performs stage 2, and function getRecBipart( ) carries out stage 3.

On this random data, each machine learning processor 208 then executes the allocation algorithm introduced above (stage 3), and then compares HRP's allocations to the allocations from two competing methodologies: 1) Quadratic optimization, as represented by CLA's minimum-variance portfolio (the only portfolio of the efficient frontier that does not depend on returns' means); and 2) traditional risk parity, exemplified by the Inverse-Variance Portfolio (IVP). See Bailey, D. and M. Lopez de Prado, “An open-source implementation of the critical-line algorithm for portfolio optimization,” Algorithms, Vol. 6, No. 1 (2013), pp. 169-196 (available at http://ssrn.com/abstract=2197616), for a comprehensive implementation of CLA, and the proof in paragraphs [0082]-[0083] above for a derivation of IVP. The processor 208 applies the standard constraints that 0≦wᵢ≦1 (non-negativity), ∀i=1, . . . , N, and Σᵢ₌₁^{N}w₁=1 (full investment). Incidentally, the condition number for the covariance matrix in this example is only 150.9324, not particularly high and therefore not unfavorable to CLA.

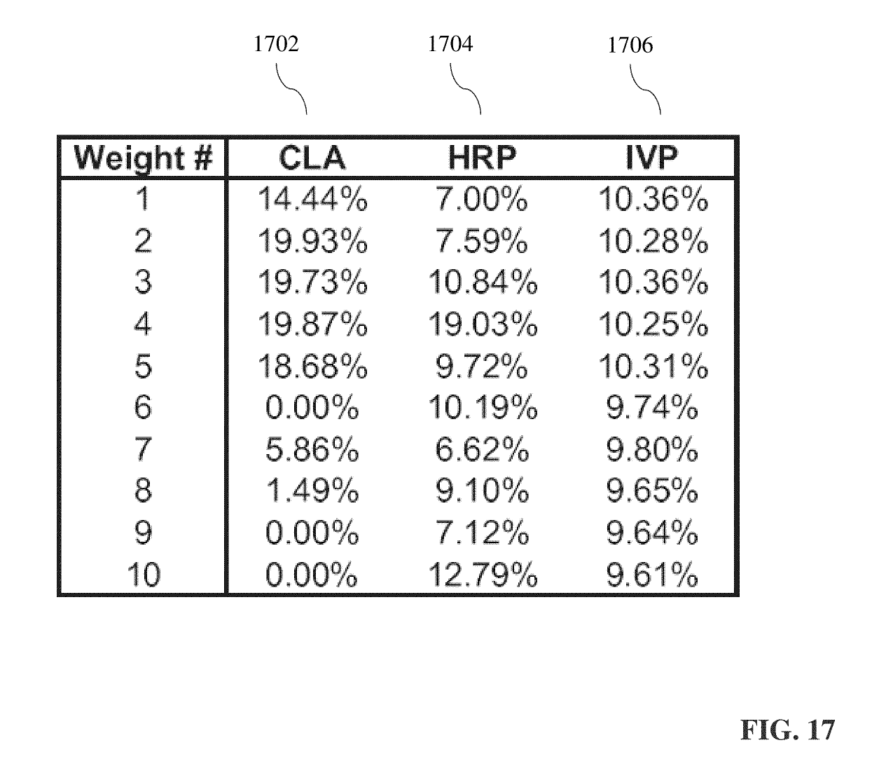

FIG. 17 depicts a table with different allocations resulting from three portfolio strategies: CLA strategy, HCA strategy, and IVP strategy. First, CLA (1702) concentrates 92.66% of the allocation on the top-five holdings, while HRP (1704) concentrates only 62.57%. Second, CLA 1702 assigns zero weight to three investments (without the 0≦wᵢ constraint, the allocation would have been negative). Third, HRP (1704) seems to find a compromise between CLA's concentrated solution and traditional risk parity's IVP (1706) allocation. From the allocations in FIG. 17, we can appreciate a few stylized features: CLA concentrates weights on a few investments, hence becoming exposed to idiosyncratic shocks. IVP evenly spreads weights through all investments, ignoring the correlation structure. This makes it vulnerable to systemic shocks. HRP finds a compromise between diversifying across all investments and diversifying across cluster, which makes it more resilient against both types of shocks. The code in FIGS. 16A-16D can be used to verify that these findings generally hold for alternative random covariance matrices.

What drives CLA's extreme concentration is its goal of minimizing the portfolio's risk. And yet both portfolios have a very similar standard deviation (σ_{HRP}=0.4640, σ_{CLA}=0.4486). So CLA has discarded half of the investment universe in favor of a minor risk reduction. The reality of course is, CLA's portfolio is deceitfully diversified, because any distress situation affecting the five top allocations will have a much greater negative impact on CLA's than HRP's portfolio.

### Out-of-Sample Monte Carlo Simulations

In the numerical example above, CLA's portfolio has lower risk than HRP's in-sample. However, the portfolio with minimum variance in-sample is not necessarily the one with minimum variance out-of-sample. It would be all too easy to pick a particular historical dataset where HRP outperforms CLA and IVP (for a discussion on overfitting and selection bias, see Bailey, D., J. Borwein, M. Lopez de Prado and J. Zhu, “Pseudo-Mathematics and Financial Charlatanism: The Effects of Backtest Overfitting on Out-Of-Sample Performance,” Notices of the American Mathematical Society, Vol. 61, No. 5 (2014), pp. 458-471 (available at http://ssrn.com/abstract=2308659) (which is incorporated herein by reference) and see Bailey D. and M. Lopez de Prado, “The Deflated Sharpe Ratio: Correcting for Selection Bias, Backtest Overfitting and Non-Normality,” Journal of Portfolio Management, Vol. 40, No. 5 (2014), pp. 94-107 (which is incorporated herein by reference).

Instead, in this section we evaluate via Monte Carlo the performance out-of-sample of HRP against CLA's minimum-variance and traditional risk parity's WP allocations. This will also help us understand what features make a method preferable to the rest, regardless of anecdotal counter-examples.

First, the system 200 generates ten series of random Gaussian returns (520 observations, equivalent to two years of daily history), with 0 mean and an arbitrary standard deviation of 10%. Real prices exhibit frequent jumps (as described in Merton, R., “Option pricing when underlying stock returns are discontinuous,” Journal of Financial Economics, Vol. 3 (1976), pp. 125-144) and returns are not cross-sectionally independent, so the system must add random shocks and a random correlation structure to the generated data. Second, the system 200 computes HRP, CLA, and IVP portfolios by looking back at 260 observations (a year of daily history). These portfolios are re-estimated and rebalanced every twenty-two observations (equivalent to a monthly frequency). Third, the system 200 computes the out-of-sample returns associated with those three portfolios. This procedure is repeated 10,000 times.

All mean portfolio returns out-of-sample are essentially 0, as expected. The critical difference comes from the variance of the out-of-sample portfolio returns: σ_{CLA}²=0.1157, σ_{IVP}²=0.0928 and σ_{HRP}²=0.0671. Although CLA's goal is to deliver the lowest variance (that is the objective of its optimization program), its performance happens to exhibit the highest variance out-of-sample, and 72.47% greater variance than HRP's. In other words, HRP would improve the out-of-sample Sharpe ratio of a CLA strategy by about 31.3%, a rather significant boost. Assuming that the covariance matrix is diagonal brings some stability to the IVP, however its variance is still 38.24% greater than HRP's. This variance reduction out-of-sample is critically important to risk parity investors, given their use of substantial leverage. See Bailey, D., J. Borwein, M. Lopez de Prado and J. Zhu, “Pseudo-Mathematics and Financial Charlatanism: The Effects of Backtest Overfitting on Out-Of-Sample Performance,” Notices of the American Mathematical Society, Vol. 61, No. 5 (2014), pp. 458-471 (available at http://ssrn.com/abstract=2308659) for a broader discussion of in-sample vs. out-of-sample performance.

The mathematical proof for HRP's outperformance over Markowitz's CLA and traditional risk parity's IVP is somewhat involved. In intuitive terms, we can understand the above empirical results as follows: Shocks affecting a specific investment penalize CLA's concentration. Shocks involving several correlated investments penalize IVP's ignorance of the correlation structure. HRP provides better protection against both, common and idiosyncratic shocks, by finding a compromise between diversification across all investments and diversification across clusters of investments at multiple hierarchical levels.

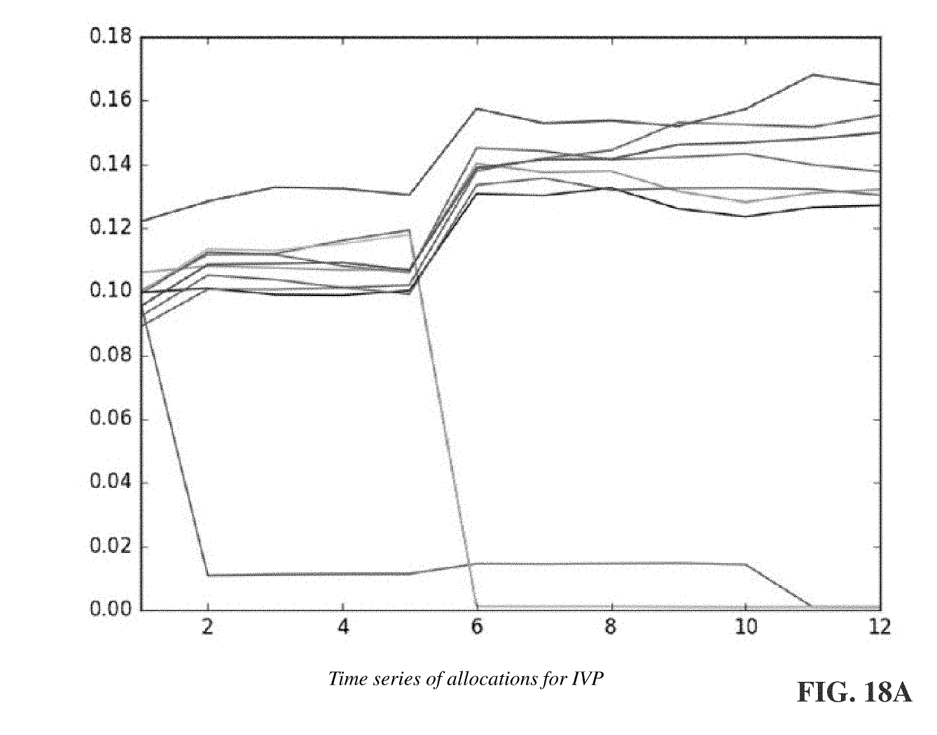

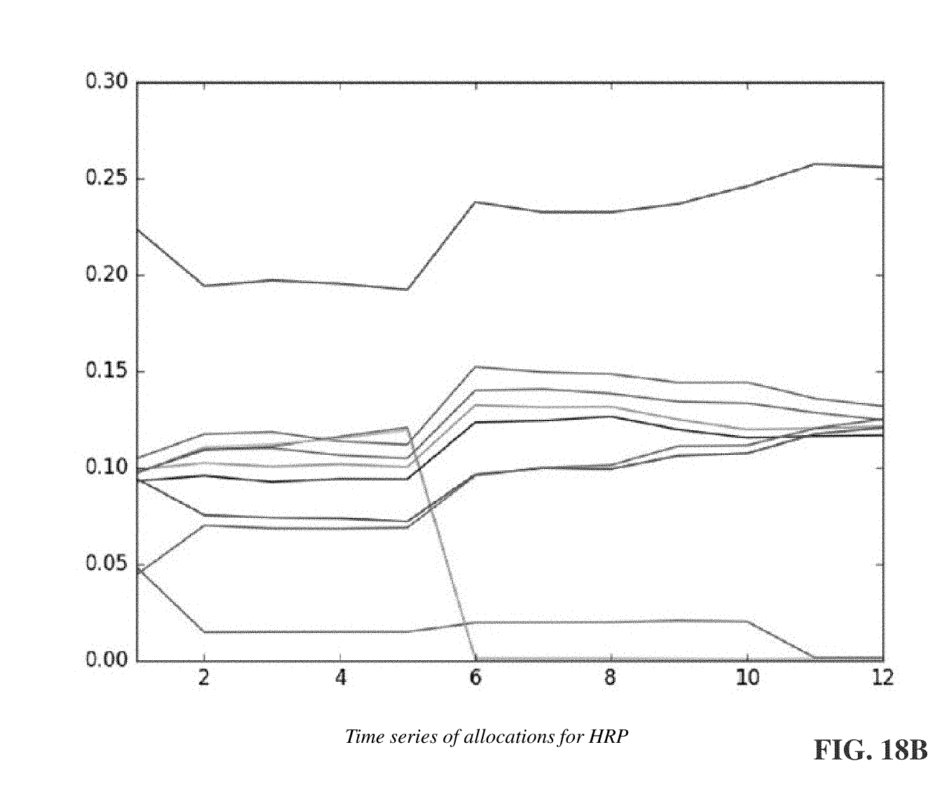

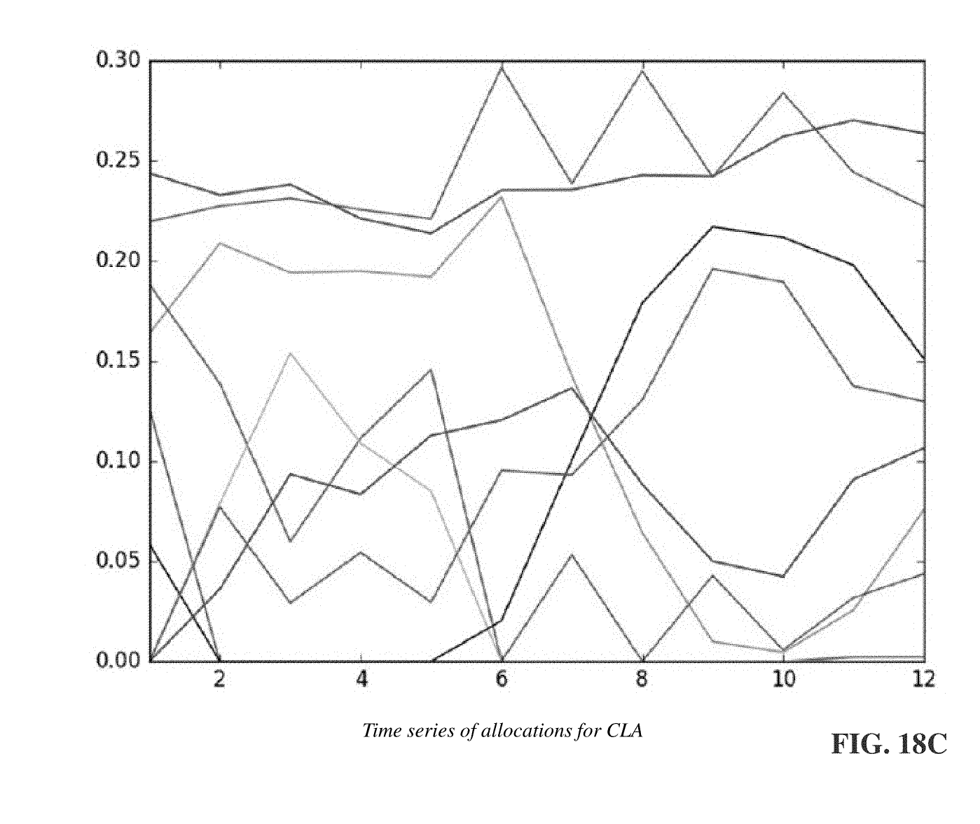

FIGS. 18A, 18B, and 18C each plots the time series of allocations for the first of the 10,000 runs for a different strategy. Between the first and second rebalance, one investment receives an idiosyncratic shock, which increases its variance. Between the fifth and sixth rebalance, two investments are affected by a common shock. As shown in FIG. 18A, IVP's response to the first shock is to reduce the allocation to that investment, and spread that former exposure across all other investments. IVP's response to the second shock is the same. As a result, allocations among the seven unaffected investments grow over time, regardless of their correlation.

As shown in FIG. 18B, HRP's response to the first (idiosyncratic) shock is to reduce the allocation to the affected investment, and use that reduced amount to increase the allocation to a correlated investment that was unaffected. As a response to the second (common) shock, HRP reduces allocation to the affected investments and increases allocation to the uncorrelated ones (with lower variance).

As shown in FIG. 18C, CLA's allocations respond erratically to idiosyncratic and common shocks. If account rebalancing costs had been taken into account, CLA's performance would have been very negative.

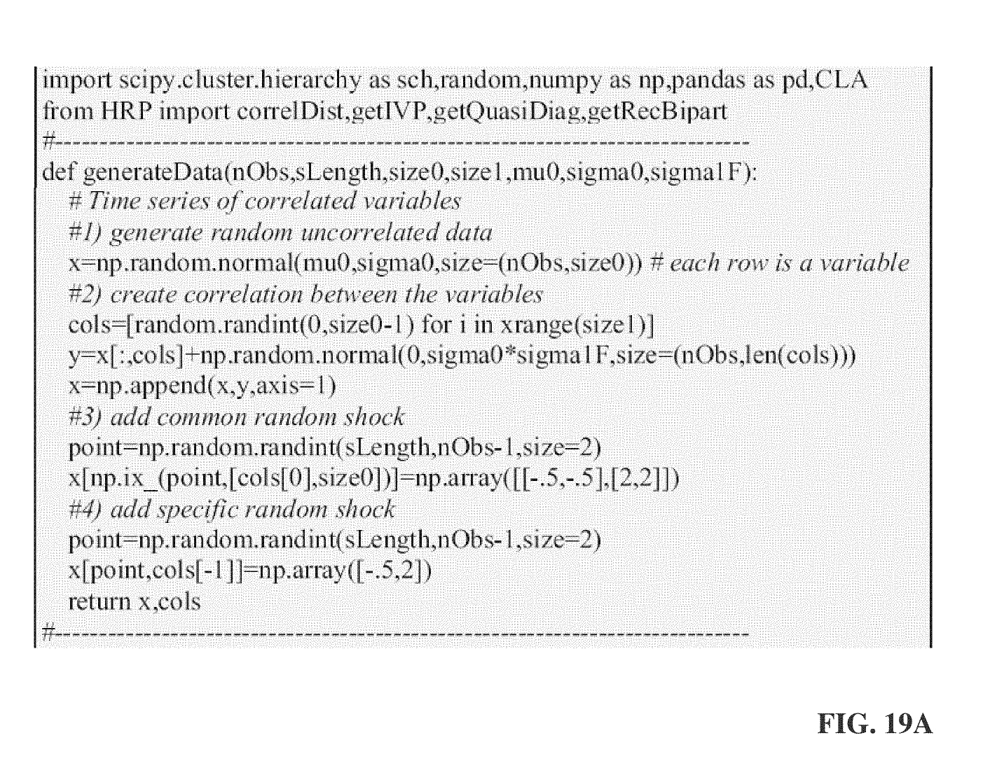

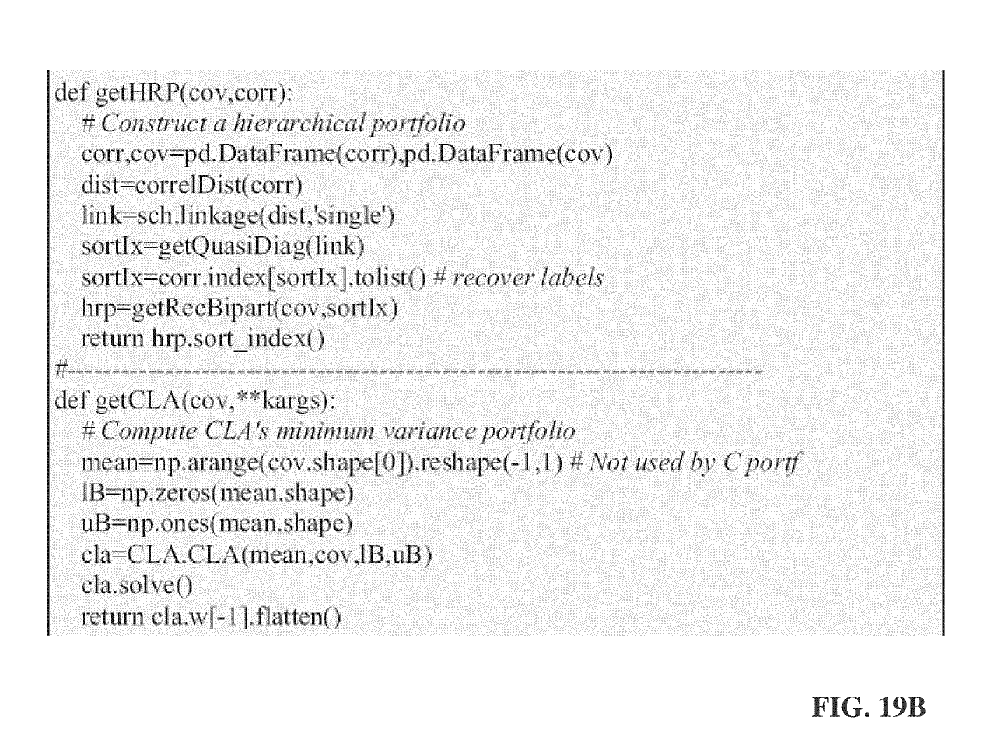

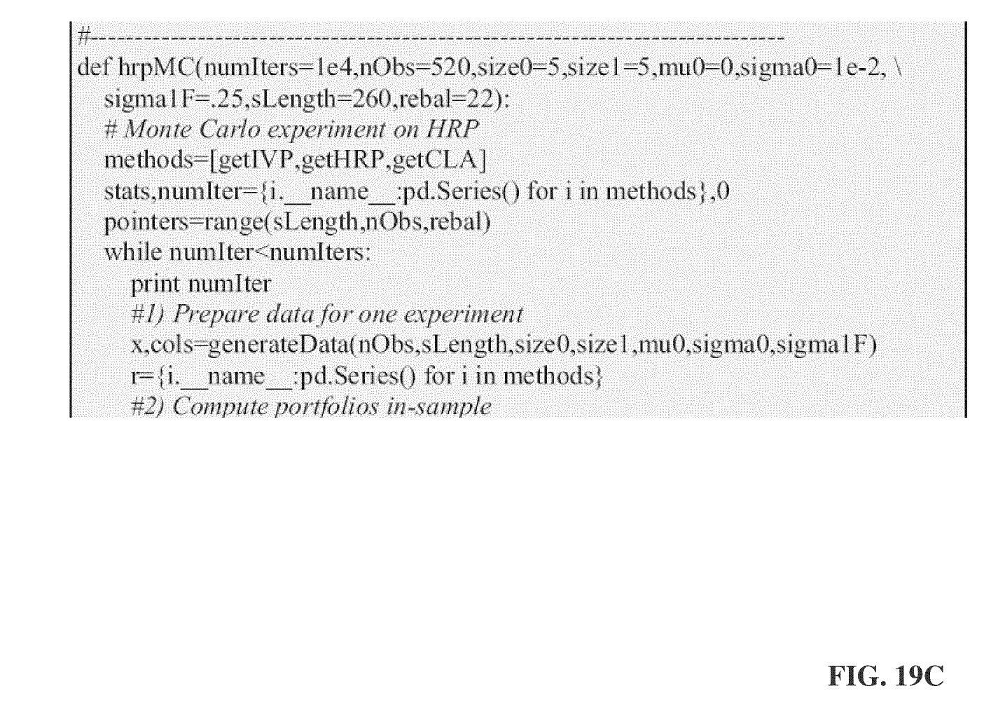

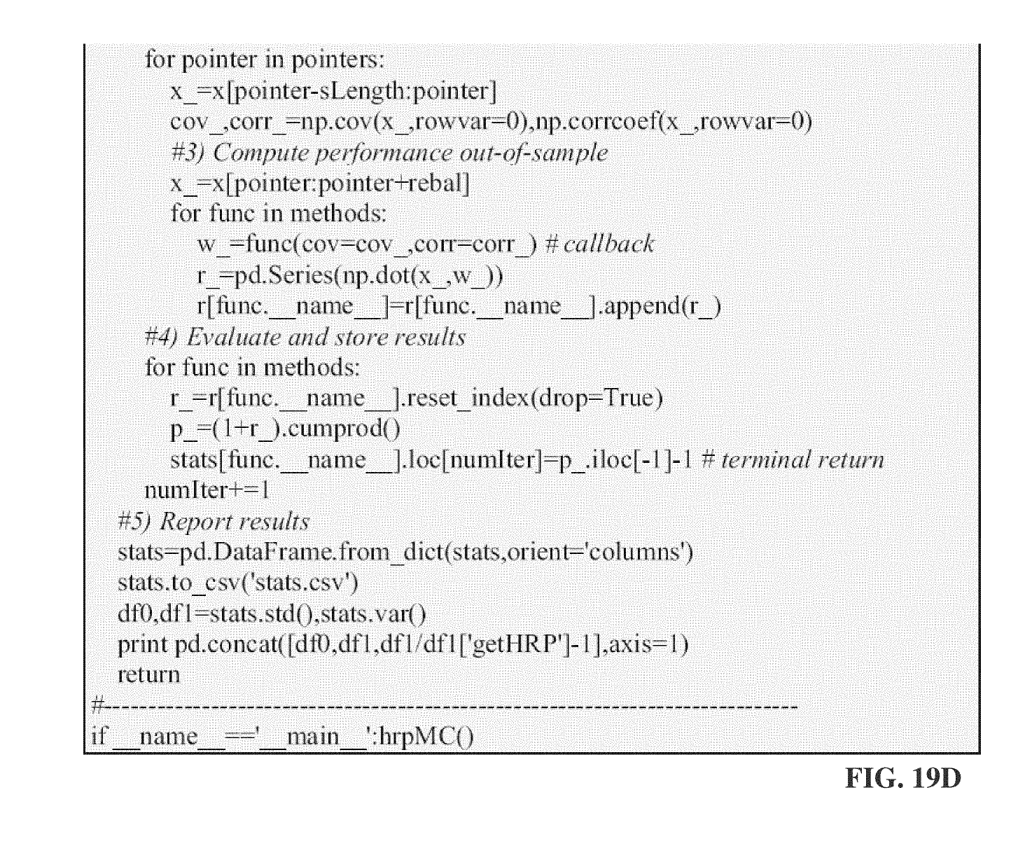

FIGS. 19A-19D provide exemplary computer code that, when executed by the processor, implements the Monte Carlo analysis described above. One of ordinary skill can utilize different parameter configurations and reach similar conclusions. In particular, HRP's out-of-sample outperformance becomes even more substantial for larger investment universes, or when more shocks are added or a stronger correlation structure is considered, or rebalancing costs are taken into account.

The methodology introduced herein is flexible, scalable, and admits multiple variations of the same ideas. Using the exemplary code provided, different HRP configurations can be researched and evaluated to determine what works best for a given problem. For example, at stage 1 alternative definitions of d_{i,j}, \tilde{d}_{i,j}, and \tilde{d}_{i,u}, or clustering algorithms, can be applied; at stage 3, different functions for \tilde{w}ₘ and α, or alternative allocation constraints, can be used. Instead of carrying out a recursive bisection, stage 3 could also split allocations top-down using the clusters from stage 1.

### CONCLUSIONS

Although mathematically correct, quadratic optimizers in general, and Markowitz's CLA in particular, are known to deliver generally unreliable solutions due to their instability, concentration and underperformance. The root cause for these issues is that quadratic optimizers require the inversion of a covariance matrix. Markowitz's curse is that the more correlated investments are, the greater is the need for a diversified portfolio, and yet the greater are that portfolio's estimation errors.

As mentioned above, a major source of quadratic optimizers' instability is: A matrix of size N is associated with a complete graph with ½N(N+1) edges. With so many edges connecting the nodes of the graph, weights are allowed to rebalance with complete freedom. This lack of hierarchical structure means that small changes in the returns series will lead to completely different solutions. HRP replaces the covariance structure with a tree structure, accomplishing three goals: a) Unlike some risk-parity methods, it fully utilizes the information contained in the covariance matrix, b) weights' stability is recovered and c) the solution is intuitive by construction. The algorithm converges in deterministic logarithmic time.

HRP is robust, visual, and flexible, allowing the user to introduce constraints or manipulate the tree structure without compromising the algorithm's search. These properties are derived from the fact that HRP does not require covariance invertibility. Indeed, HRP can compute a portfolio on an ill-degenerated or even a singular covariance matrix, an impossible feat for quadratic optimizers.

Although the example provided herein focuses on a portfolio construction application, it should be appreciated that other practical uses for making decisions under uncertainty can be found, particularly in the presence of a nearly-singular covariance matrix: Capital allocation to portfolio managers, allocations across algorithmic strategies, bagging and boosting of machine learning signals, forecasts from random forests, replacement to unstable econometric models (VAR, VECM), etc.

Of course, quadratic optimizers like CLA produce the minimum-variance portfolio in-sample (that is its objective function). Monte Carlo experiments show that HRP delivers lower out-of-sample variance than CLA or traditional risk parity methods (e.g., IVP). Since Bridgewater pioneered risk parity in the 1990s, some of the largest asset managers have launched funds that follow this approach, for combined assets in excess of $500 billion. Given their extensive use of leverage, these funds should benefit from adopting a more stable risk parity allocation method, thus achieving superior risk-adjusted returns and lower rebalance costs.

### Application of HRP Optimal Portfolio Allocation in Trading Software

The techniques described above can be leveraged in a software application for a computerized trading system that uses the HRP optimal portfolio allocation to issue buy/sell orders. The following section describes the technical details surrounding the software application and the hardware environment in which it is implemented.

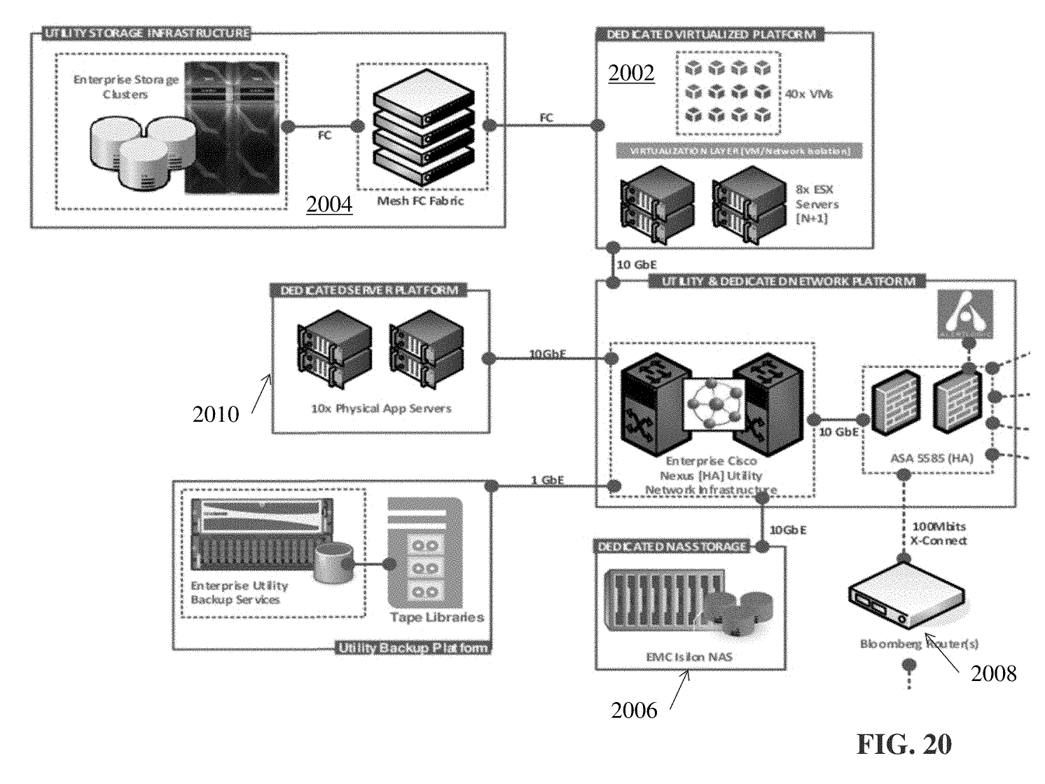

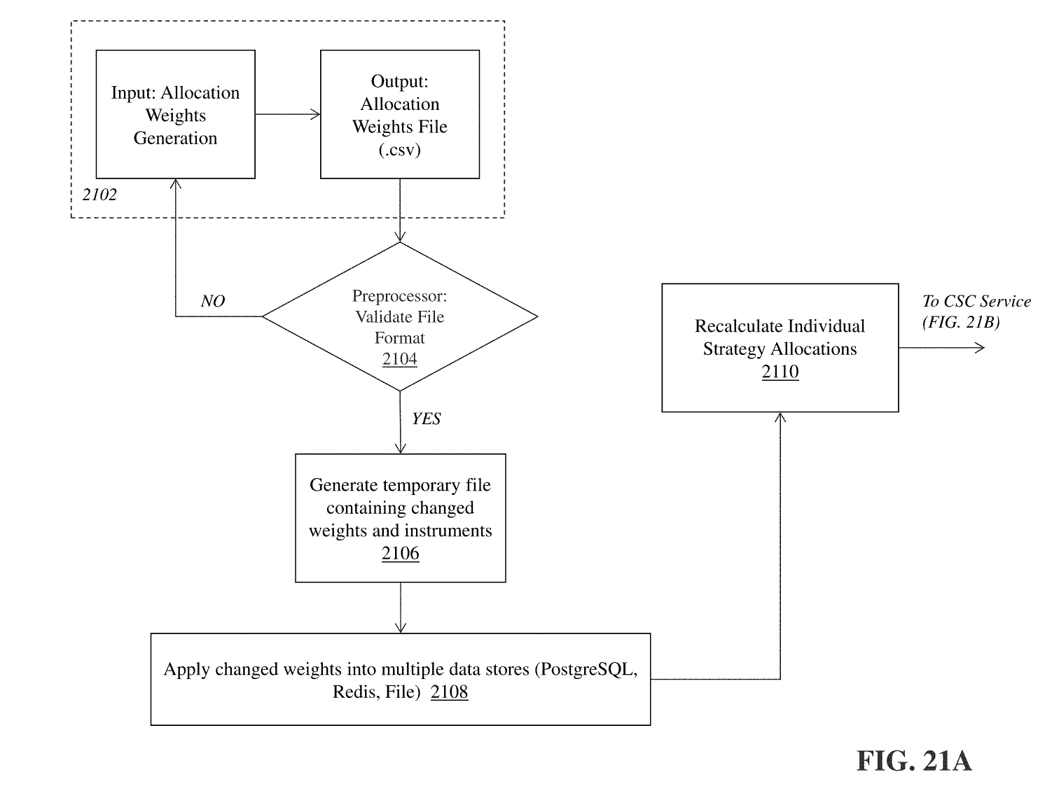

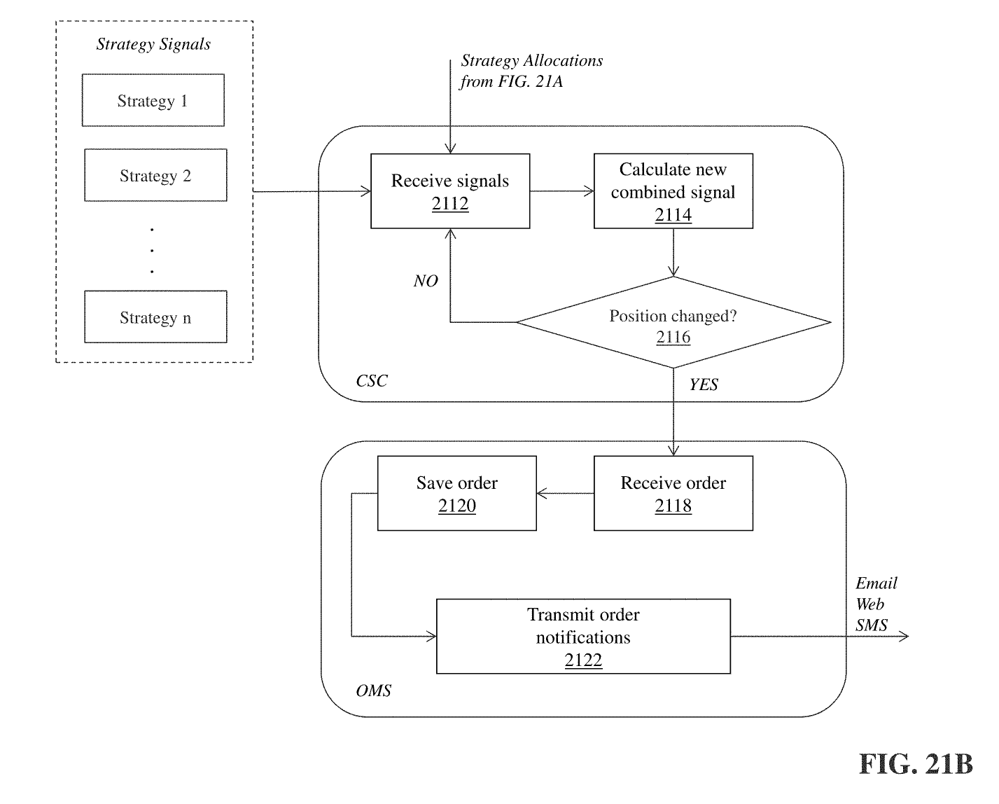

The purpose of the software is to aggregate strategy signals, calculate an overall position, issue a buy/sell order, and send notifications. An exemplary hardware architecture for implementing the software application is shown in FIG. 20. The service applications described below with respect to FIGS. 21A and 21B (CSC, OMS, RabbitMQ, Redis) run on a virtualized machine platform 2002. The VM (virtual machine) provides redundancy from hardware and operating system-failures. The storage system for each VM is mounted from a central block-level SAN storage device 2004. Central file-sharing NAS storage is provided by an EMC Isilon device 2006. The network is connected at 10 g speeds by Cisco routers. Incoming market data comes via a proprietary Bloomberg device 2008. Strategy signal data is generated on a cluster of physical application servers 2010 using a distributed messaging system. Specifications for an exemplary CPU used by the system are provided in Appendix A, and specifications for an exemplary server device used by the system are provided in Appendix B.

The software consists of two components, the CSC (Combined Strategies Calculator) and the OMS (Order Management Service). The services are implemented using the Python language and run on the 2.7× series interpreters and various 3rd-party modules (an exemplary list of modules and version numbers is provided in Appendix C).

FIGS. 21A and 21B are a flow diagram of a method for applying the optimized portfolio allocations generated by the HRP algorithm to issue buy/sell orders in a computerized trading system of FIG. 20.

The system uses input of allocation weights and generates a file (e.g., a .CSV file) containing allocation weights per strategy 2102. The system runs a preprocessor on the allocation weights file to validate (2104) the instruments and strategies contained therein are set up in the system. If no, then the system returns to the allocation weights generation step 2102.

If yes, the system generates (2106) a temporary intermediate file with changed instruments and weights. The system then applies (2108) the changed weights into multiple data stores, such as PostgreSQL (version 9.2), Redis (version 3.2.4), and NAS file system. The system validates the changed weights by recalculating (2110) individual strategy allocations. A job schedule in the system then restarts the CSC and OMS.

Turning to FIG. 21B, the individual strategies feed data into the CSC/OMS. The CSC receives (2112) new incoming signals from strategies (e.g., via RabbitMQ) and waits if there are no incoming new signals. The CSC calculates (2114) a “combined” signal based upon weights & allocations, derives a buy/sell order, and the expected current position. The expected current position is derived based upon the combined signal, the AUM, and the specific characteristics of the traded instrument. If the position has not changed, the CSC waits to receive new incoming signals. If the position has changed, the CSC transmits the buy/sell order details to the OMS.

The OMS receives (2118) the buy/sell order from the CSC. It should be appreciated that there is bidirectional communication between the CSC and OMS to capture for warnings and exceptions. The OMS saves (2120) the order details in the data stores (e.g., PostgreSQL, Redist, NAS file system). The OMS generates (2122) order notifications to notify traders of the signal, the new buy/sell order to execute, and the expected current position. The OMS maps executed trades from executing brokers to the original order for reconciliation purposes. The OMS can be queried for current positions, history of strategy signals, and history of orders at any point of time. Traders can “claim” orders via the OMS to avoid other traders executing the same order. Risk & PnL for each instrument is shown using a web-based GUI.

The communication between software components is done via a messaging system implemented via RabbitMQ (version 3.6.5-1). The messages transferred on the messaging system are compressed and proprietary. The messaging system is clustered for redundancy. The system is accessed via a generic non-machine specific naming scheme using HAProxy (version 1.5.18). The process is monitored by a system called Keepalived (version 1.2.13) to ensure constant uptime.

The CSC/OMS save their state to multiple data stores upon any incoming signal: NAS (Network Attached Storage) file system, Redis NoSQL in-memory cache, and PostgreSQL relational database. The primary data store is PostgreSQL file system due to its transactional capability.

The orders to execute are communicated to traders via email, mobile SMS, and a web-based GUI. Orders can be “claimed” via the web-based GUI or by mobile SMS.

Reconciliation with the expected current position and the executed position is done by interacting with prime brokers via real-time FIX feeds.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A system for generating a hierarchical data structure using clustering machine learning algorithms, the system comprising:
a cluster of server computing devices communicably coupled to each other and to a database computing device, each server computing device having one or more machine learning processors, the cluster of server computing devices programmed to:
a) receive a matrix of observations;
b) derive a robust covariance matrix from the matrix of observations;
c) divide the matrix of observations into a plurality of computation tasks and transmit each of the plurality of computation tasks to a corresponding machine learning processor;
d) generate, by each machine learning processor, a first data structure for a distance matrix based upon the corresponding computation task, the distance matrix comprising a plurality of items;
e) determine, by each machine learning processor, a distance between any two column-vectors of the distance matrix;
f) generate, by each machine learning processor, a cluster of items using a pair of columns associated with the two column-vectors;
g) define, by each machine learning processor, a distance between the cluster and unclustered items of the distance matrix;
h) update, by each machine learning processor, the distance matrix by appending the cluster and defined distance to the distance matrix and dropping clustered columns each rows of the distance matrix;
i) append, by the machine learning processor, one or more additional clusters to the distance matrix by repeating steps f)-h) for each additional cluster;
j) generate, by each machine learning processor, a second data structure for a linkage matrix using the clustered distance matrix;
k) reorganize, by each machine learning processor, rows and columns of the linkage matrix to generate a quasi-diagonal matrix;
l) recursively bisect, by each machine learning processor, the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance;
m) generate, by each machine learning processor, a third data structure containing the clusters and assigned weights; and
n) consolidate each third data structure from each machine learning processor into a solution vector and transmit the solution vector to a remote computing device.

2. The system of claim 1, wherein generating a first data structure for a distance matrix further comprises:
generating robust covariance and correlation matrices based upon the corresponding computation task;
defining a distance measure using the correlation matrix; and
generating the first data structure based upon the correlation matrix and the distance.

3. The system of claim 1, wherein the distance between any two column-vectors of the distance matrix comprises a proper distance metric, such as the Euclidian distance.

4. The system of claim 1, wherein the distance between the cluster and unclustered items of the distance matrix is determined using a mathematical criterion, such as the nearest point algorithm.

5. The system of claim 1, wherein the remote computing device uses the weights in the hierarchical data structure to rebalance an asset allocation for a financial portfolio.

6. The system of claim 1, wherein each server computing device includes a plurality of machine learning processors, each machine learning processor having a plurality of processing cores.

7. The system of claim 1, wherein each processing core of each machine learning processor receives and processes a portion of the corresponding computation task.

8. A computerized method of generating a hierarchical data structure using clustering machine learning algorithms, the method comprising:
a) receiving, by a cluster of server computing devices communicably coupled to each other and to a database computing device and each server computing device comprising one or more machine learning processors, a matrix of observations;
b) deriving, by the cluster of server computing devices, a robust covariance matrix from the matrix of observations;
c) dividing, by the cluster of server computing devices, the matrix of observations into a plurality of computation tasks and transmitting each of the plurality of computation tasks to a corresponding machine learning processor;
d) generating, by each machine learning processor, a first data structure for a distance matrix based upon the corresponding computation task, the distance matrix comprising a plurality of items;
e) determining, by each machine learning processor, a distance between any two column-vectors of the distance matrix;
f) generating, by each machine learning processor, a cluster of items using a pair of columns associated with the two column-vectors;
g) defining, by each machine learning processor, a distance between the cluster and unclustered items of the distance matrix;
h) updating, by each machine learning processor, the distance matrix by appending the cluster and defined distance to the distance matrix and dropping clustered columns and rows of the distance matrix;
i) appending, by each machine learning processor, one or more additional clusters to the distance matrix by repeating steps f)-h) for each additional cluster;
j) generating, by each machine learning processor, a second data structure for a linkage matrix using the clustered distance matrix;
k) reorganizing, by each machine learning processor, rows and columns of the linkage matrix to generate a quasi-diagonal matrix;
l) recursively bisecting, by each machine learning processor, the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance;
m) generating, by each machine learning processor, a third data structure containing the clusters and assigned weights; and
n) consolidating the third data structure from each machine learning processor into a solution vector and transmitting the solution vector to a remote computing device.

9. The method of claim 8, wherein generating a first data structure for a distance matrix further comprises:
generating robust covariance and correlation matrices based upon the corresponding computation task;
defining a distance measure using the correlation matrix; and
generating the first data structure based upon the correlation matrix and the distance.

10. The method of claim 8, wherein the distance between any two column-vectors of the distance matrix comprises a proper distance metric, such as the Euclidian distance.

11. The method of claim 8, wherein the distance between the cluster and unclustered items of the distance matrix is determined using a mathematical equation, such as the nearest point algorithm.

12. The method of claim 9, wherein the remote computing device uses the weights in the hierarchical data structure to rebalance an asset allocation for a financial portfolio.

13. The method of claim 8, wherein each server computing device includes a plurality of machine learning processors, each machine learning processor having a plurality of processing cores.

14. The method of claim 14, wherein each processing core of each machine learning processor receives and processes a portion of the corresponding computation task.

15. A computer program product, tangibly embodied in a non-transitory computer readable storage device, for generating a hierarchical data structure using clustering machine learning algorithms, the computer program product comprising instructions that when executed, cause a cluster of server computing devices communicably coupled to each other and to a database computing device, each server computing device comprising one or more machine learning processors, to:
a) receive a matrix of observations;
b) derive a robust covariance matrix from the matrix of observations;
c) divide the matrix of observations into a plurality of computation tasks and transmit each one of the plurality of computation tasks to a corresponding machine learning processor;
d) generate, by each machine learning processor, a first data structure for a distance matrix based upon the corresponding computation task, the distance matrix comprising a plurality of items;
e) determine, by each machine learning processor, a distance between any two column-vectors of the distance matrix;
f) generate, by each machine learning processor, a cluster of items using a pair of columns associated with the two column-vectors;
g) define, by each machine learning processor, a distance between the cluster and unclustered items of the distance matrix;
h) update, by each machine learning processor, the distance matrix by appending the cluster and defined distance to the distance matrix and dropping clustered columns and rows of the distance matrix;
i) append, by each machine learning processor, one or more additional clusters to the distance matrix by repeating steps e)-g) for each additional cluster;
j) generate, by each machine learning processor, a second data structure for a linkage matrix using the clustered distance matrix;
k) reorganize, by each machine learning processor, rows and columns of the linkage matrix to generate a quasi-diagonal matrix;
l) recursively bisect, by each machine learning processor, the quasi-diagonal matrix by: assigning a weight to each cluster in the quasi-diagonal matrix, bisecting the quasi-diagonal matrix into two subsets, defining a variance for each subset, and rescaling the weight of each cluster in a subset based upon the defined variance;
m) generate, by each machine learning processor, a third data structure containing the clusters and assigned weights; and
n) consolidate each third data structure from each machine learning processor into a solution vector and transmitting the solution vector to a remote computing device.
